(19) United States
(12) Patent Application Publication
(10) Pub. No.: US 2025/0173891 A1
(43) Pub. Date: May 29, 2025

(54) HUMAN POSE RECOGNITION USING SYNTHETIC IMAGES AND VIEWPOINT/POSE ENCODING

(71) Applicant: The Regents of The University of California, Oakland, CA (US)

(72) Inventors: Saad Manzur, Irvine, CA (US); Wayne Brian HAYES, Irvine, CA (US)

(73) Assignee: The Regents of The University of California, Oakland, CA (US)

(21) Appl. No.: 18/964,484

(22) Filed: Dec. 1, 2024

Related U.S. Application Data
(63) Continuation-in-part of application No. 18/749,898, filed on Jun. 21, 2024.
(60) Provisional application No. 63/522,381, filed on Jun. 21, 2023.

(51) Int. Cl. G06T 7/70; G06T 11/20; G06T 15/20

(52) U.S. Cl. CPC G06T 7/70; G06T 11/206; G06T 15/20; G06T 2207/10016; G06T 2207/20072; G06T 2207/20081; G06T 2207/20084; G06T 2207/30196

(57) ABSTRACT

A device receives a real image (e.g., photograph or video frame) that includes a human. The device creates a synthetic image corresponding to the real image. The synthetic image includes a synthetic environment and a humanoid shape that correspond to the human. The device predicts, using a trained viewpoint neural network and based on the synthetic image, a predicted viewpoint heatmap. The device predicts, using a trained pose neural network and based on the synthetic image, a predicted pose heatmap. The device provides, as input to a random synthetic environment, the predicted viewpoint heatmap and the predicted pose heatmap and creates a reconstructed three-dimensional pose based on the predicted viewpoint heatmap, the predicted pose heatmap, and the random synthetic environment. The device classifies the reconstructed three-dimensional pose as a particular type of pose of the human in the real image.

### CROSS-REFERENCE TO RELATED APPLICATIONS

This application is a continuation-in-part of U.S. patent application Ser. No. 18/749,898, titled “Human Pose Recognition Using Abstract Images And Viewpoint/Pose Encoding”, filed on Jun. 21, 2024, which claims the benefit of U.S. Provisional Application 63/522,381, titled “Human Pose Recognition Using Abstract Images And Viewpoint/Pose Encoding”, filed on Jun. 21, 2023. Both applications are hereby incorporated by reference for all purposes.

### BACKGROUND OF THE INVENTION

### Field of the Invention

Human pose estimation may include identifying and classifying joints in the human body. For example, human pose estimation models may capture a set of coordinates for each limb (e.g., arm, head, torso, etc.,) or joint (elbow, knee, etc.) used to describe a pose of a person. Typically, in 2D pose estimation, the term “keypoint” may be used, while in 3D pose estimation, the term “joint” may be used. However, it should be understood that the terms limb, joint, and keypoint are used interchangeably herein. A human pose estimation model may analyze an image or a video (e.g., a stream of images) that includes a person and estimate a position of the person's skeletal joints in either two-dimensional (2D) space or three-dimensional (3D) space.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIGS. 1A, 1B, 1C are diagrams illustrating various poses and views, in accordance with some embodiments.

FIG. 2 is a diagram illustrating a system to perform human pose recognition, in accordance with some embodiments.

FIG. 3A is a diagram illustrating a synthetic environment, in accordance with some embodiments.

FIG. 3B is a diagram illustrating a synthetic image, in accordance with some embodiments.

FIG. 4A is a diagram illustrating limb generation from a vector, in accordance with some embodiments.

FIG. 4B is a diagram illustrating torso generation from right and forward vectors, in accordance with some embodiments.

FIG. 5A is a diagram illustrating an approach to encoding a viewpoint, in accordance with some embodiments.

FIG. 5B is a diagram illustrating a rotation invariant approach to encoding a viewpoint, in accordance with some embodiments.

FIG. 5C is a diagram illustrating seam lines after computing cosine distances, in accordance with some embodiment of the invention.

FIG. 5D is a diagram illustrating a Gaussian heatmap wrapped horizontally to form a continuous cylindrical coordinate system, in accordance with an embodiment of the invention.

FIG. 6A is a diagram illustrating a synthetic image (also referred to as an “abstract image”) fed into a human pose recognition network, in accordance with some embodiments.

FIG. 6B is a diagram illustrating a predicted viewpoint heatmap, in accordance with some embodiments.

FIG. 6C is a diagram illustrating a reconstructed pose that is reconstructed from pose heatmaps and viewpoint heatmaps, in accordance with some embodiments.

FIG. 6D is a diagram illustrating a ground-truth 3D pose, in accordance with some embodiments.

FIGS. 7A, 7B, 7C are diagrams illustrating a first input image, prediction, ground truth, respectively, in accordance with some embodiments.

FIGS. 7D, 7E, 7F are diagrams illustrating a second input image, prediction, ground truth, respectively, in accordance with some embodiments.

FIGS. 7G, 7H, 7I are diagrams illustrating a third input image, prediction, ground truth, respectively, in accordance with some embodiments.

FIGS. 7J, 7K, 7L are diagrams illustrating a fourth input image, prediction, ground truth, respectively, in accordance with some embodiments.

FIG. 8A, 8B, 8C, 8D illustrate predictions corresponding to input images, in accordance with some embodiments.

FIG. 9 is a flowchart of a process that includes training a viewpoint network and a pose network, according to some embodiments.

FIG. 10 is a flowchart of a process that includes creating a reconstructed 3D pose based on a viewpoint heatmap, a pose heatmap, and a random synthetic environment, according to some embodiments.

FIG. 11 is a flowchart of a process that includes performing pose reconstruction and transforming a camera's position from subject-centered coordinates to world coordinates, according to some embodiments.

FIG. 12 is a flowchart of a process that includes training a generative adversarial neural network using multiple tiles, according to some embodiments.

FIG. 13 is a flowchart of a process to train a machine learning algorithm, according to some embodiments.

FIG. 14 is a flowchart of a process that includes generating a reconstructed 3D pose from a real image, according to some embodiments.

FIG. 15 is a flowchart of a process that includes providing a pre-processed image as input to an image-to-abstract network, according to some embodiments.

FIG. 16 is a flowchart of a process that includes generating an abstract representation based on a pose encoding and a viewpoint encoding, according to some embodiments.

FIG. 17 illustrates an example configuration of a computing device that can be used to implement the systems and techniques described herein.

FIG. 18A illustrates data of error vs vertical bins/rows for several techniques, based on experimental data.

FIG. 18B illustrates azimuth relative to subject for several techniques, based on experimental data.

FIG. 18C illustrates elevation relative to subject for several techniques, based on experimental data.

FIG. 19A illustrates error vs missing limbs for several techniques, based on experimental data.

FIG. 19B illustrates error vs scale for several techniques, based on experimental data.

FIG. 19C illustrates an effect of wrapping, based on experimental data.

### DETAILED DESCRIPTION

The systems and techniques described herein employ a representation using opaque 3D limbs to preserve occlusion information while implicitly encoding joint locations. When training an artificial intelligence (AI) using data with accurate three-dimensional keypoints (also referred to as joints herein), the representation allows training on abstract synthetic images (also referred to as “abstract images” or “synthetic images”), with occlusion, from as many viewpoints as desired. In many cases, the result is a pose defined by limb angles rather than joint positions—because poses are, in the real world, independent of cameras—allowing the systems and techniques described herein to predict poses that are completely independent of the camera's viewpoint. This provides not only an improvement in same-dataset benchmarks, but significant improvements in cross-dataset benchmarks. Note that the terms artificial intelligence (AI), machine learning (ML), Convolutional neural network (CNN), and network (e.g., a graph network or neural network) are utilized interchangeably herein, and more generally all of them refer to any type of automated learning system applied to pose recognition.

A 3D “ground truth” pose is a three-dimensional location of all the limbs of a human body (“person”) computed using existing datasets. Most existing datasets are derived from users (“subjects”) wearing a “motion capture suit,” which has special visible markers on the joints (shoulders, elbows, knees, hips, etc.), which are easily visible, and the subject's pose may be captured simultaneously from multiple angles such that individual joints are usually visible from at least one camera. In some cases, a goal of the AI may be to recover positions using only one of the images and to do so without markers, e.g., using only a single two-dimensional photo. Most conventional systems “train” an AI using two-dimensional projections of the three-dimensional locations of these joints, including joints that may not be visible from a particular direction. A major issue with such a method is that the 2D location of the dots that represent the joint locations do not typically include information about which joints are visible and which are not, e.g., occlusion is not represented in the training set, and because real images include invisible (occluded) joints, the conventional systems perform badly on such images, even though such images are common in the real world.

The systems and techniques described herein address the issues present in conventional systems. Rather than training the AI using “dots” representing joints, the AI is trained using “Synthetic images,” in which joints are not depicted as dots. Instead, a limb between a pair of joints is represented as an opaque solid (e.g., an arm, a forearm, a leg, a torso, etc.). As a consequence, occluded joints are not visible, as they are in the real world. Thus, the AI is able to learn about occlusion using this type of training data.

In some cases, the systems and techniques may not use normalization and typically have cross-dataset results of about 4 cm (1.5 inches), with a worst-case of about 9 cm (3 inches). In contrast, conventional systems must be “normalized” on a per-dataset basis, for example the system must learn where the subject usually appears in the image, how large the subject is in pixels, how far the joints tend to be away from each other in pixels, and their typical relative orientations. Note that this “normalization” must be pre-performed on the entire image dataset beforehand, which is why conventional techniques are not useful in the real world, because new images are constantly being added to the dataset in real time. Thus, to perform adequately across datasets, existing prior art systems must perform this normalization first, on both (or all) datasets. Without this normalization, the cross-dataset errors can be up to 50 cm (about 20 inches). Even with this pre-computed normalization, the errors are typically 10 cm (about 4 inches) up to 16 cm (7 inches).

In some cases, the systems and techniques may tie together the pose and the camera position, in such a way that the camera's position is encoded relative to the subject, and the subject's pose is encoded relative to the camera. For example, if an astronaut strikes exactly the same pose on Earth, the Moon, or Mars, or even in (or rotating in) deep space, and a photo is taken from a viewpoint 3 feet directly to the left of his/her left shoulder, then the astronaut's pose relative to the camera, and the camera's position relative to the astronaut, is the same in each cases, and the encoding system described herein provides the same answer for both pose and viewpoint in each of these cases. In contrast, conventional systems, trained for example on Earth, would attempt to infer the camera's position in some fixed (x, y, z) co-ordinates, and would likely fail on the Moon, Mars, or floating in space. This example illustrates the importance of encoding used by the systems and techniques to take an image as input and explicitly output numbers representing the pose. One technical complication is that a full encoding may include information not only of the person's pose, but also the viewpoint the camera had when it took the picture—with both, it is possible to synthetically reconstruct the person's pose as seen by the camera when it took the photo. The technical problem is that, because conventional techniques currently work on only one dataset, and the cameras are all in fixed locations within one dataset, conventional techniques output literal (x, y, z) co-ordinates of the joints without any reference to the camera positions, which are fixed in one dataset. Thus, conventional techniques are incapable of properly accounting for a different camera viewpoint in another dataset. If they attempt to do so, they often encode the literal camera positions in the room in three dimensions, and then try to “figure out” where in the room (or the world) the camera may be in a new dataset, again in three dimensions. These “world” coordinates of the camera, combined with the world coordinates of the joints, result in a mathematical problem called the many-to-one problem: the same human pose, with an unknown camera location, has many encodings; likewise, the camera position given an (as yet) unknown pose, has many encodings. These issues induce a fundamental, unsolvable mathematical problem: the function from image to pose is not unique (not “1-to-1”).

The systems and techniques described herein recognize human poses in images using synthetic images and viewpoint/pose encoding (also referred to as “human pose recognition”). Several features of the systems and techniques are described herein. The systems and techniques can be used on (applied to) a dataset that is different from the dataset the systems and techniques were trained on.

Given an image, a goal of human pose estimation (and the systems and techniques) is to extract the precise locations of a person's limbs and/or joints from the image. However, this may be difficult because depth information (e.g., what is in front of or behind something) is typically not present and may be difficult to automatically discern from images. Further, conventional techniques may start with the image directly, or try to extract the locations of joints (e.g., knees, elbows, etc.) first and then infer the limbs. Typically, such conventional techniques also require the user to wear special clothing with markers on the joints. Conventional techniques work well (with typical errors of 1.5-2.5 inches) only when tested on (applied to) the same dataset (e.g., same environment, same room, same camera setup, same special clothing), but perform poorly when tested on (applied to) different datasets—referred to as cross-dataset performance—with typical errors of 6-10 inches. Furthermore, primary shortcoming of conventional techniques is that they only work in one setting: they are trained and tested on the same dataset (i.e., same system, same room, same cameras, same set of images). Such conventional techniques are unable to be trained in one scenario and then work in (be applied to) a new environment with a different camera, subject, or environment.

Most people (humans) can look at a picture of another person (the “subject”) and determine the pose of the subject such as, but not limited to, how they were standing/sitting, where their limbs are, etc. This is true regardless of the environment that the subject is in, whether in a forest, inside a building, or on the streets of Manhattan, people can usually determine the pose. Conventional techniques perform poorly “in the wild” (with typical errors of 4-6 inches), while methods trained “in the wild” have within-dataset errors of about 3 inches, and cross-dataset errors of 6 or more inches. However, instead of blindly feeding a dataset into a system, the systems and techniques intelligently extract information. Further, this is not useful in the real world, where a user with a phone camera or webcam may want to know the pose of their subject, even though the phone camera or webcam has not been part of the training system (this is called “cross-dataset performance”). The systems and techniques address such problems, as further described below.

The systems and techniques simultaneously address at least three major technical weaknesses of conventional systems. These three technical weaknesses are as follows. First, conventional systems are trained and tested in only one environment and thus do not perform well in an unknown environment. Second, conventional systems require a dataset-dependent normalization in order to obtain good results across datasets, whereas the systems and techniques do not require such normalization. Third, conventional systems ignore the role of the camera's position (because the camera or cameras have fixed positions in any one given dataset), whereas the systems and techniques include camera position in their encoding (e.g., viewpoint encoding), and thus allow for transferring knowledge of both camera and pose between datasets.

The systems and techniques use minimal opaque shape-based representation instead of a 2D keypoint based representation. Such a representation preserves occlusion and creates space to generate synthetic datapoints to improve training. Moreover, the viewpoint and pose encoding scheme used by the systems and techniques may encode, for example, a spherical or cylindrical continuous relationship, helping the machine to learn the target. It should be noted that the main focus is not the arrangement of the camera and that different types of geometric arrangements can be mapped through some type of transformation function onto the encoding and these geometric arrangements are not restricted to the spheres or cylinders that are merely used as examples. Included herein is data from experiments that demonstrates the robustness of this encoding and illustrates how this approach achieves an intermediate representation while retaining information valuable for 3D human pose estimation and can be adopted to any training routine, enabling a wide variety of applications for the systems and techniques.

### Human Pose Recognition

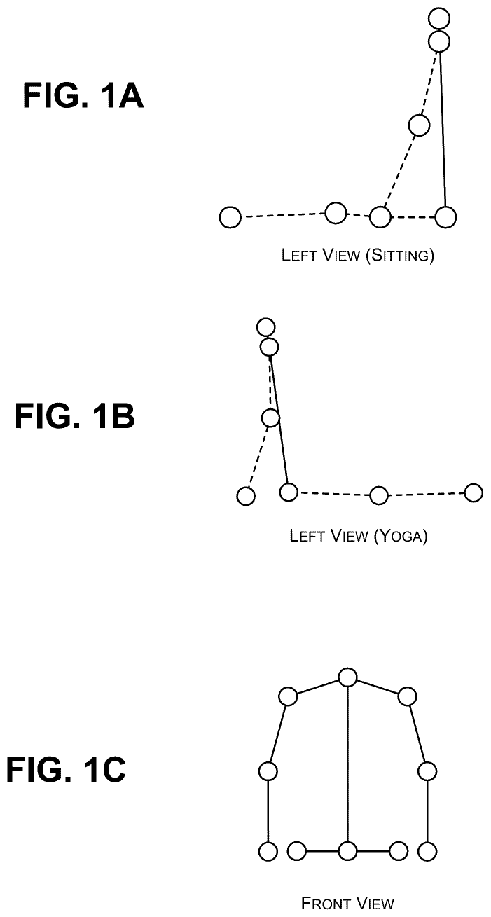

Viewpoint plays an important role in understanding a human pose. For example, distinguishing left from right is important when determining a subject's orientation. 2D stick figures cannot preserve relative ordering when the left and right keypoints (also referred to as joints herein) overlap with each other. FIGS. 1A and 1B capture images of different poses while FIG. 1C illustrates a front view in which both FIG. 1A and FIG. 1B pose generate the same image. For example, FIG. 1A illustrates a left view of a person sitting on the floor with their arms to their sides, FIG. 1B illustrates a left view of a person doing yoga (e.g., cobra pose), and FIG. 1C illustrates a front view of either FIG. 1A or FIG. 1B. In these three figures, limb occlusion is excluded, making the front view of FIGS. 1A and 1B relatively indistinguishable from each other. To improve cross-dataset performance, the systems and techniques described herein: (1) avoid depending on any metric derived from the training set, (2) estimate a viewpoint accurately, and (3) avoid discarding occlusion information.

A pose of a person may be defined using angles between limbs at their mutual joint, rather than their positions. The most common measure of error in pose estimation is not pose error, but position error, which is most often implicitly tied to z-score normalization. Z-score normalization, also known as standardization, is a data pre-processing technique used in machine learning to transform data such that the data has a mean of zero and a standard deviation of one. To enable cross-dataset applications, the systems and techniques use error measures that relate to pose, rather than position.

To improve cross-dataset performance, the systems and techniques described herein train an artificial intelligence (AI) using training data that includes a large number (e.g., tens of thousands to millions) of synthetic (e.g., computer-generated) images of opaque, solid-body humanoid-shaped beings across a huge dataset of real human poses, taken from multiple camera viewpoints. Viewpoint bias is addressed by using a viewpoint encoding scheme that creates a 1-to-1 mapping between the camera viewpoint and the input image, thereby solving the many-to-one problem. A similar 1-to-1 encoding is used to define each particular pose. Both encodings support fully-convolutional training. Using the synthetic (“abstract”) images as input to two neural networks (a type of AI), one neural network is trained for viewpoint and another neural network is trained for pose. At inference time, the predicted viewpoint and pose are extracted from the synthetic image and used to reconstruct a new 3D pose. Since reconstruction does not ensure the correct forward-facing direction of the subject, the ground-truth target pose is related to the reconstructed pose by a rotation which can be easily accounted for, compared to conventional methods. A Fully Convolutional Network (FCN) is a type of artificial neural network with no dense layers, hence the name fully convolutional. An FCN may be created by converting classification networks to convolutional ones. An FCN may be designed for semantic segmentation, where the goal is to classify each pixel in an image. An FCN transforms intermediate feature maps back to the input image dimensions. The FCN may use a convolution neural network (CNN) to extract image features. These features capture high-level information from the input image. Next, a 1×1 convolutional layer reduces the number of channels to match the desired number of classes. This basically maps the features to pixel-wise class predictions. To restore the spatial dimensions (height and width) of the feature maps to match the input image, the FCN uses transposed convolutions (also known as deconvolutions). These layers up-sample the feature maps. The output of the FCN has the same dimensions as the input image, with each channel corresponding to the predicted class for the corresponding pixel location.

### Training Phase

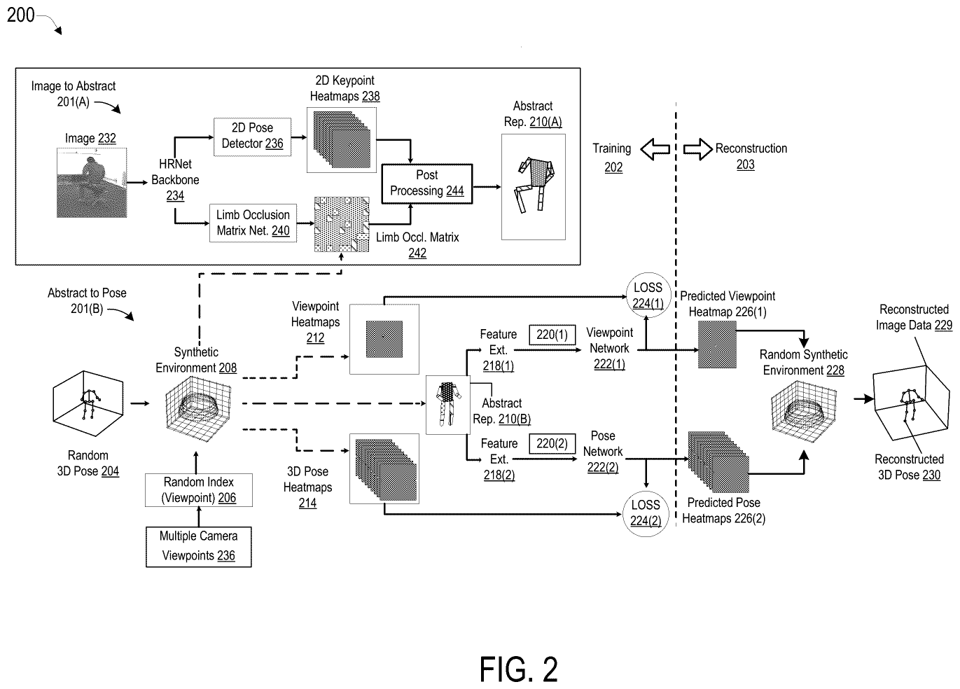

FIG. 2 illustrates a system 200 to perform human pose recognition, according to some cases. FIG. 2 includes a training phase 202 in which multiple machine learning algorithms are trained and a reconstruction (generative) phase 203. The term “network” refers to a neural network, a type of machine learning algorithm.

First, an image-to-abstract network 201(A) takes as input an image 232 and uses an HRNet backbone 234 to pass the image through (1) a 2D pose detector 236 to create 2D keypoint heatmaps 238 and through (2) a limb occlusion matrix network 240 to create a limb occlusion matrix 242. HRNet backbone 234 is used merely as an example. Depending on the implementation, HRNET backbone 234 may be replaced with another similar backbone to achieve the results described herein. The 2D pose detector and the limb occlusion matrix networks may, in some cases, be part of the same network as well. For example, one network may branch into two separate heads with a same backbone feature extractor network. The image-to-abstract network 201(A) reduces (minimizes) (1) a binary cross-entropy loss for a limb occlusion matrix 238 and (2) mean squared error (MSE) loss for 2D keypoint heatmaps 240. Post processing 244 is performed on the 2D keypoint heatmaps 238 and the limb occlusion matrix 242 to create an abstract representation 210. The result of the image to abstract 201(A) is the abstract representation 210 with limb occlusion matrix as a z-buffer and 2D keypoints as the core structure. In the reconstruction phase 203, the system 200 generates abstract images (both flat and cube variants) from a random viewpoint and 3D pose pairs using a synthetic environment. The viewpoint and pose heatmaps are generated from a synthetic environment and are used as supervision targets for the abstract representation to viewpoint and pose networks. The abstract to pose 201(B) network optimizes the L2 loss on the output of viewpoint and pose network. The reconstruction 203 takes viewpoint and pose heatmaps and uses a random synthetic environment to reconstruct a 3D pose 230, as described below.

In a training phase 202, multiple pairs of poses and viewpoints are used to generate a synthetic environment from which synthetic images, viewpoint heatmaps, and pose heatmaps are derived. For example, as shown in FIG. 2, a representative randomly selected 3D pose 204 and a representative randomly selected viewpoint 206 are used to generate a synthetic environment 208 from which are derived an abstract representation 210(A), a viewpoint heatmap 212, and pose heatmaps 214. In training, we may produce two variants 210(A), 210(B) interchangeably at random to make the training more robust to either. The viewpoint heatmap 212 and pose heatmaps 214 are used as supervised training targets. Backbone feature extraction (neural) network 218(1), 218(2) may be used to extract features 220(1), 220(2) to train a viewpoint (neural) network 222(1) and a pose (neural) network 222(2), respectively. For example, the feature extraction networks 218(1), 218(2) take as input the synthetic environment 208, extract features 220(1), 220(2), and feed the extracted features 220(1), 220(2) to the viewpoint network 222(1) and the pose network 222(2), respectively. An L2 loss 224(1) is optimized (minimized) for the output of the viewpoint network 222(1) based on the viewpoint heatmap 212 generated from the synthetic environment 208 and an L2 loss 224(2) is optimized (minimized) for the output of the pose network 222(2) based on the pose heatmaps 214 generated from the synthetic environment 208. The L2 loss 224(1), 224(2) are also known as Squared Error Loss, and are determined using the squared difference between a prediction and the actual value, calculated for each example in the dataset. The aggregation of all these loss values is called the cost function, where the cost function for L2 is commonly MSE (Mean of Squared Errors).

### Reconstruction Phase

After the training phase 202 has been completed, in a reconstruction phase 203 (also referred to as the inference phase or generation phase), the trained viewpoint network 222(1) takes synthetic images as input and generates (predicts) a viewpoint heatmap 226(1). The trained pose network 222(2) takes synthetic images as input and generates (predicts) a pose heatmap 226(2). The heatmaps 226(1), 226(2) are passed into a random synthetic environment 228 to create reconstructed image data 229 that includes a reconstructed 3D pose 230. In some cases, the heatmaps 226 may include a location map or a “fuzzy” map. In some cases, the heatmaps 226 may specify a fuzzy location and may represent only one possible fuzzy location. In some cases, the heatmaps 226 may take a shape in any number of dimensions (e.g., 2D, 3D, 4D, etc.). For example, if the systems and techniques are used for video, the heatmaps 226 include time as an added dimension, thus making the heatmaps 226 at least 3D.

Note that one of the unique aspects of the systems and techniques described herein is that (1) the camera viewpoint as seen from the subject and (2) the subject's observed pose as seen from the camera, are independent. Although both are tied together in the sense that both are needed to fully reconstruct a synthetic image, each of the two answer completely separate questions. Thus, (1) the location of the camera as viewed from the subject is completely independent of the subject's pose and (2) the pose of the subject is completely independent of a location of the camera. In the real world, these are two separate questions whose answers have absolutely no relation to each other. However, to reconstruct an abstract representation of the image (as it was actually taken by a real camera) in the real world, the answers to both are used.

Note that humans can easily identify virtually any pose observed as long as there is observable occlusion, which disambiguates many poses that would be indistinguishable without it. Thus, there exists a virtual 1-to-1 mapping between two-dimensional images and three-dimensional poses. Similarly, a photographer can infer where they are with respect to the subject (e.g., “behind him” or “to his left,” etc.) and in this way, there is also a 1-to-1 mapping between the image and the subject-centered viewpoint.

The systems and techniques may be used to decompose 3D human pose recognition into the above two orthogonal questions: (1) where is the camera located in subject-centered coordinates, and (2) what is the observed pose, in terms of unit vectors along the subject's limbs of the subject in camera coordinates as seen from the camera? Note that identical three-dimensional poses as viewed from different angles may change both answers, but combining the answers enables reconstructing a subject-centered pose that is the same in all cases.

In some cases, by incorporating occlusion information, two fully convolutional systems can be independently trained: a first convolutional system learns a 1-to-1 mapping between images and the subject-centered camera viewpoint, and a second convolutional system learns a 1-to-1 mapping between images and camera-centered limb directions. In some cases, subject-centered may not mean “subject in dead center.” In some cases, the subject may be used as a reference coordinate system. In addition, in some cases, multiple subjects may be used as a reference coordinate system in which a coordinate system is derived from multiple subjects in the scene. In some cases, the reference coordinate system can also be a part or limb of the subject. The systems and techniques train the two convolutional neural network (CNN)'s (e.g., the networks 222(1), 222(2)) using a large (virtually unlimited) set of “abstract” (synthetic computer-generated) images 234 of humanoid shapes generated from randomly chosen camera viewpoints 236 observing the ground-truth 3D joint locations of real humans in real poses, with occlusion. Given a sufficiently large (synthetic) dataset of synthetic images, the two CNNs (e.g., the networks 222(1), 222(2)) may be independently trained to reliably encode the two 1-to-1 mappings. In some cases the networks 222(1), 222(2) may be independently trained, while in other cases, they may be trained jointly (in a co-dependent manner).

As further described below, (1) the human body is modeled using solid, opaque, 3D shapes such as cylinders and rectangular blocks that preserve occlusion information and part-mapping, (2) novel viewpoint and pose encoding schemes are used to facilitate learning a 1-to-1 mapping with input while preserving a spherical prior, and (3) the systems and techniques result in state-of-the-art performance in cross-dataset benchmarks, without relying on dataset dependent normalization, and without sacrificing same-dataset performance.

The systems and techniques estimate the viewpoint accurately, avoid discarding occlusion information, and avoid camera-dependent metrics derived from the training set. This is done by training on synthetic “abstract” images of real human poses viewed from a virtually unlimited number of viewpoints. We address the viewpoint bias (FIG. 1) with an encoding that creates a mathematical 1-to-1 mapping between the camera viewpoint and the input image; a similar 1-to-1 encoding defines the pose. Both encodings support fully-convolutional training. As depicted in FIG. 2, the techniques use the abstract image as input to two networks: one for viewpoint, and another for pose. At inference time, we (1) generate the abstract image from a real image, and (2) take the predicted viewpoint and pose from the abstract image to reconstruct the 3D pose. Since reconstruction does not ensure the correct forward-facing direction of the subject, the ground-truth target pose is related to the reconstructed pose by a simple rotation to compare with other methods. A key observation is that the camera viewpoint as seen from the subject, and the subject's observed pose as seen from the camera, are independent: although they are intimately tied together in the sense that both are needed to fully reconstruct an abstract image—and thus a pose—they answer completely separate questions. Specifically, (1) the location of the camera as viewed from the subject is completely independent of the subject's pose and (2) the pose of the subject is completely independent of where the camera is located. The “abstract-to-pose” part of our method (Stage 2) decomposes 3D human pose recognition into the above two orthogonal components: (1) the camera's location in subject-centered coordinates, and (2) the observed pose of the subject in camera coordinates. Note that identical three-dimensional poses from different viewpoints will change both answers, but combining the answers allows us to reconstruct the same subject-centered pose. One of the key aspects of the systems and techniques is that by incorporating occlusion information, we can independently train two fully convolutional systems: (1) one that learns a 1-to-1 mapping between images and the subject-centered camera viewpoint, and (2) another that learns a 1-to-1 mapping between images and camera-centered pose. The final ingredient is to train these two CNN's using a large set of abstract images, with occlusion, generated from randomly chosen camera viewpoints observing the ground-truth 3D joint locations of real humans in real poses. Given a sufficiently large (synthetic) dataset of abstract images, we are able to independently train two CNNs that reliably encode the two 1-to-1 mappings. After the above CNNs are trained, the last ingredient we need for a true image-to-pose is a technique to create an abstract image from a real input image. We outline our “image-to-abstract” technique below which shows competitive performance indicating adaptability in real-world scenarios. The systems and techniques use “stick figures” with abstract images as the intermediate representation between images and poses. We represent limbs as opaque, solid, rectangular blocks that preserve occlusion and part-mapping. Using 2D/3D GT keypoints, we can generate synthetic abstract images from an unlimited number of camera viewpoints. The systems and techniques use special viewpoint and pose encoding schemes, which facilitate learning a 1-to-1 mapping with input while preserving a spherical prior. The systems and techniques significantly improve performance in cross-dataset benchmark without relying on dataset dependent normalization.

Although a specific example of human pose recognition systems was discussed above with respect to FIGS. 1A, 1B, 1C, and 2, it should be understood that various human pose recognition systems may be implemented using the systems and techniques described herein.

### Human Pose Recognition

For 3D pose estimation, the systems and techniques use (i) a form of position regression with a fully connected layer at the end, or (ii) a voxel-based approach with fully-convolutional supervision. The voxel-based approach generally comes with a target space size of w×x h×d×N, where w is the width, h height, d depth, and N is the number of joints. On the other hand, the position regression typically uses some sort of training set dependent normalization (e.g., z-score). Both the graph convolution-based approach and hypothesis generation approach may use z-score normalization to improve same-dataset and, particularly, cross-dataset performance. A pose encoding scheme is used that is fully-convolutional and has a smaller memory footprint in contrast to a voxel-based approach (by a factor of d) and does not depend on normalization parameters from training set.

Some conventional techniques may apply an unsupervised part-guided approach to 3D pose estimation. In this approach, part-segmentation is generated from an image with the help of intermediate 3D pose and a 2D part dictionary. In contrast, the systems and techniques use supervised learning with a part-mapped synthetic image to predict viewpoint and 3D pose.

Viewpoint estimation generally includes regressing some form of (θ, ϕ), rotation matrix, or quaternions. Regardless of the particular approach used, viewpoint estimation is typically relative to the subject. However, relative subject rotation makes it harder to estimate viewpoint accurately. To address this, the systems and techniques have the AIs (networks 222(1), 222(2)) trained on synthetically generated images of “robots”, e.g., artificial (e.g., computer generated) human-like shapes having cylinders or cuboids as limbs, body, head, and the like. The pose of these robots is derived from ground-truth 3D human poses. It should be noted that the use robots is merely exemplary and any type of shapes may be used in the systems and techniques described herein. In some cases, each robot may have opaque, 3D limbs that are uniquely color-coded (implicitly defining a part-map). Although a particular color (e.g., color of limbs) are utilized, it should be understood that any color and/or combination of colors may be used. Further, any color may be used for a background color. For example, the present cases may use a black background (or any other color as appropriate in accordance with the systems and techniques described herein). The 2D projection of such a representation is referred to herein as an “abstract image,” because the representation includes the minimum information used to completely describe a human pose. Considerations of converting real images into abstract ones are further described below.

Most conventional approaches use regression on either 3D joint positions or voxels. However, tests show that the former performs extremely badly across datasets when the same z-score parameters are used for both training and test sets and improves only marginally if the normalization parameters are independently computed for both training and test sets (which is not feasible in the field as mentioned above, but is shown in Table 3, below). Conversely, voxel regression presents a trade-off in performance vs. memory footprint as voxel resolution is increased. In contrast, the pose encoding described herein (1) does not require training set dependent normalization, (2) takes much less memory than a voxel-based representation (by a factor of d), and (3) it integrates well into a fully convolutional setup because it is heatmap-based. Further, conventional techniques may encode the viewpoint using a rotation matrix, sine and cosines, or quaternions. However, all of these techniques suffer from a discontinuous mapping at 2π. In contrast, the systems and techniques described herein avoid discontinuities by training the network(s) (e.g., 222(1), 222(2)) on a Gaussian heat-map of viewpoint (or pose) that wraps around at the edge. As a result, the network(s) learn that the heatmap can be viewed as being on a cylinder.

### Systems and Techniques for Pose Estimation

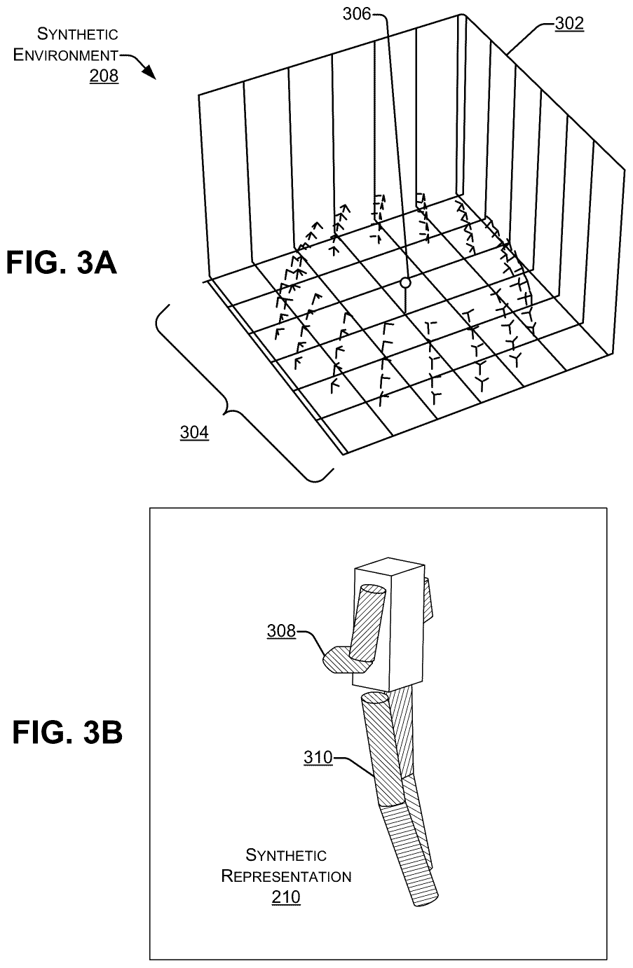

FIG. 3A illustrates a synthetic environment, according to some embodiments. The synthetic environment 208 includes a room 302 with multiple cameras 304 arranged spherically and pointing to a same fixed point 306 at the center of the room 302. Define \vec{T}∈ [symbol] ^{X×Y×3} as the translation/position of the cameras 304 in X columns and Y rows. The fixed point 306 is defined as,

$$\vec{f} = \frac{c}{X Y} \sum \vec{T}$$

where c<0.5. The constant (c) controls the height of the fixed point from the ground, which helps the cameras 304 positioned at the top to point down from above. This may be used during training to account for a wide variety of possible camera positions at test time.

The synthetic environment 208 includes multiple cameras 304 arranged spherically and pointing to \vec{f} (fixed point 306). As shown in FIG. 3A, each of the cameras 304 is related to the room 302 via a rotation matrix, R∈ [symbol] ^{X×Y×3}. Determine a look vector as \vec{l}ᵢⱼ=\vec{f}-\vec{T}ᵢⱼ for camera (i, j) and take a cross-product with −\hat{z} as the up vector to compute the right vector, \vec{r}, all of which are fine-tuned to satisfy orthonormality by a series of cross-products. Predefined values are discussed below.

FIG. 3B illustrates an abstract (“synthetic”) image, according to some embodiments. The terms “abstract” and “synthetic” are used interchangeably to describe an environment or an image that is computer-generated. To provide occlusion information associated with the synthetic images used in the training data, the synthetic image 210 (“robot”) has 8 limbs and torso that may be represented using 9 easily distinguishable, high-contrast colors (or different types of shading, as shown in FIG. 3B). For example, if left forearm 308 and femur 310 are colored blue, then the AI can easily determine where the abstract (image) representation 210 is facing. In contrast, a “stick figure” representation that does not include occlusion information may cause the AI to have difficulties determining the “front facing” direction. The 3D joint locations define the endpoints of the appropriate limbs (e.g., the upper and lower arm limbs meet at the 3D location of the elbow). In contrast to conventional systems that used unsupervised training on rigid transformations of 2D spatial parts, the systems and techniques described herein analytically generate the abstract representation 210 with opaque limbs and torso intersecting at the appropriate 3D joint locations.

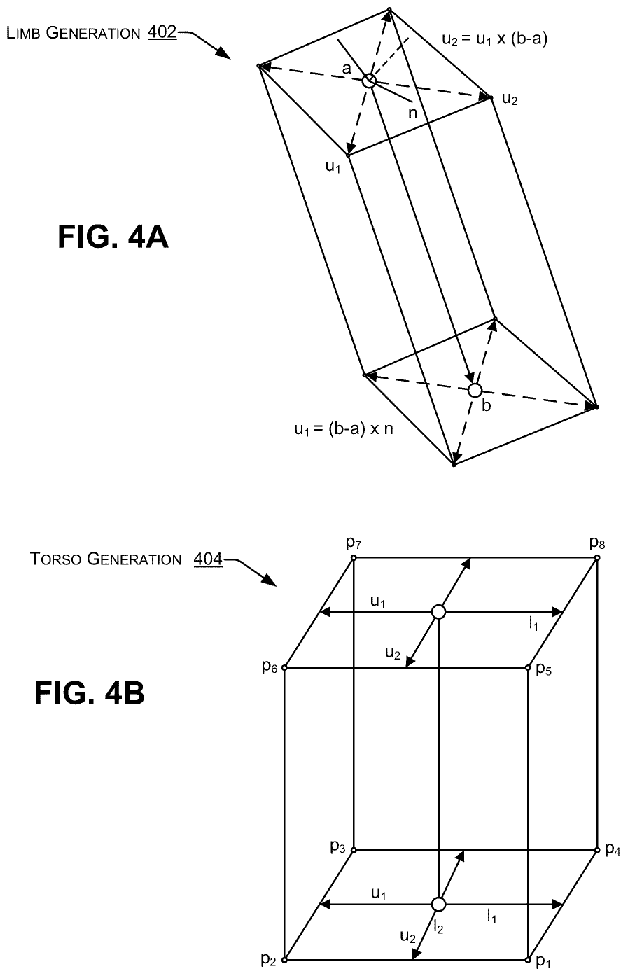

FIG. 4A is a diagram illustrating limb generation from a vector, in accordance with some embodiments. FIG. 4B is a diagram illustrating torso generation from right and forward vectors, in accordance with some embodiments. Limbs and torso may be formed by cuboids with orthogonal edges formed via appropriate cross-products. A limb 402 in FIG. 4A has a long axis (a to b) along a bone with a square cross-section. A torso 404 in FIG. 4B is longest along the spine and has a rectangular cross-section. While the limb cuboid in FIG. 4A may be generated from a single vector (a to b), the torso 404 in FIG. 4B may be generated with the help of a body centered coordinate system.

The abstract shapes come in two variants: Cube and Flat. Using a mixture of both helps the network learn the underlying pose structure without overfitting. To provide occlusion information that is clear in both variants, our robot's 8 limbs (FIG. 4A) and torso (FIG. 4B) use multiple (e.g., 9 or more) easily-distinguishable, high-contrast colors.

The Cube Variant has 3D limbs and torso formed by cuboids with orthogonal edges formed via appropriate cross-products; limbs (FIG. 4A) have a long axis (a to b) along the bone with a square cross-section, while the torso (FIG. 4B) is longest along the spine and has a rectangular cross-section. While the limb cuboid is generated from a single vector (a to b), the torso is generated by a body-centered coordinate system. All endpoints are compiled into a matrix X_{3D}∈ [symbol] ^{3×N}, where N is the number of vertices. We project these points to X_{2D}∈ [symbol] ^{2×N} using the focal length f_{cam} and camera center ccam (predefined for a synthetic room). Using the QHull algorithm, we compute the convex hull of the projected 2D points for each limb. We compute the Euclidean distance between each part's midpoint and the camera. Next, we iterate over the parts in order of longest distance, extract the polygon from hull points, and assign limb colors. While obtaining the 3D variant this way, we obtain a binary limb occlusion matrix for 1 limbs, L∈Zl×l, where each entry (u, v) determines whether limb u is occluding limb v if there is polygonal overlap above certain threshold.

Algorithm 1: Abstract Shape Generation

| Data: P_{cam} ∈ [symbol] ^{3 × N}, f_{cam}, c_{cam}, colors ∈ [symbol] ^{N × 3} | |
|---|---|
| Result: [symbol] | |
| X_{3D} ← compute_cuboids(P_{cam}); | |
| X_{2D} ← project_points(X_{3D}, f_{cam}, c_{cam}); | |
| H_{2D} ← QHull(X_{2D}); | |
| D ← sort(compute_distance(P_{cam})); | |
| [symbol] ∈ [symbol] ^{W × H × 3}; | |
| for i in descending order of D do | |
| \| | polyᵢ ← extract_polygon(H_{2D}[i]); |
| \| | [symbol] [polyᵢ] ← Colorsᵢ |

end

Let all the endpoints be compiled in a matrix, X_{3D}∈ [symbol] ^{3×N}, where N is number of parts. These points are projected to 2D X_{2D}∈ [symbol] ^{2×N} using the focal length f_{cam} and camera center c_{cam} (predefined for a synthetic room). Using the QHull (Algorithm 1 above), compute the convex hull of the projected 2D points for each limb. Compute the Euclidean distance between each part's midpoint and the camera. Next, iterate over the parts in order of longest distance, extract the polygon from hull points, and assign limb colors (or shading).

The Flat Variant utilizes the limb occlusion matrix L and 2D keypoints X2D to render the abstract image. L is used to topologically sort the order to render the limbs farthest to nearest. The limbs in this variant can be easily obtained by rendering a rectangle with the 2D endpoints forming a principal axis. If the rectangle area is small—for example if the torso is sideways or a limb points directly at the camera—we inflate to make the limbs more visible. We follow a similar approach while rendering the torso with four endpoints (two hips and two shoulders).

### Viewpoint Encoding

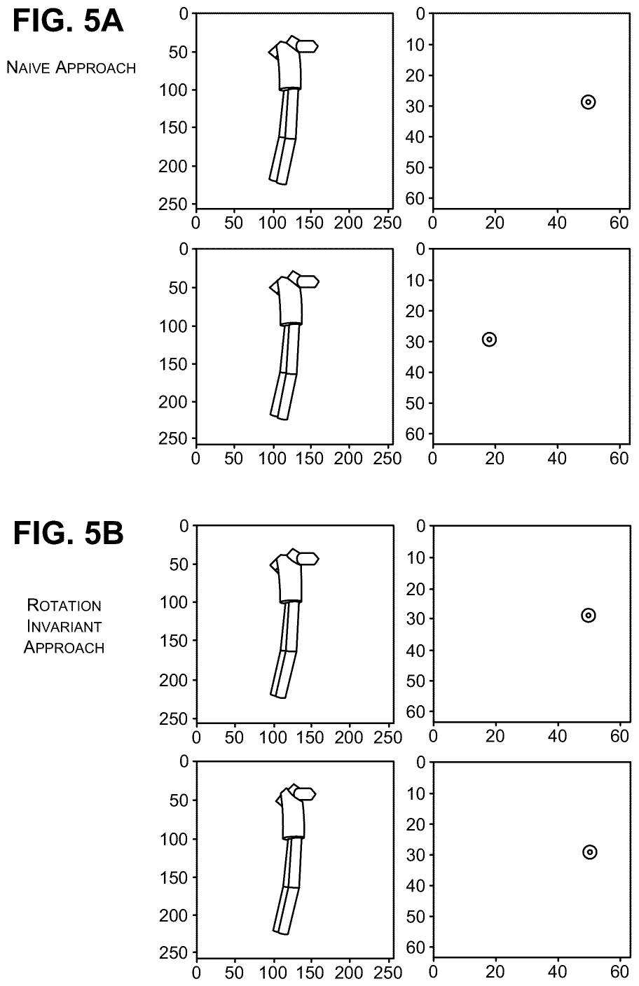

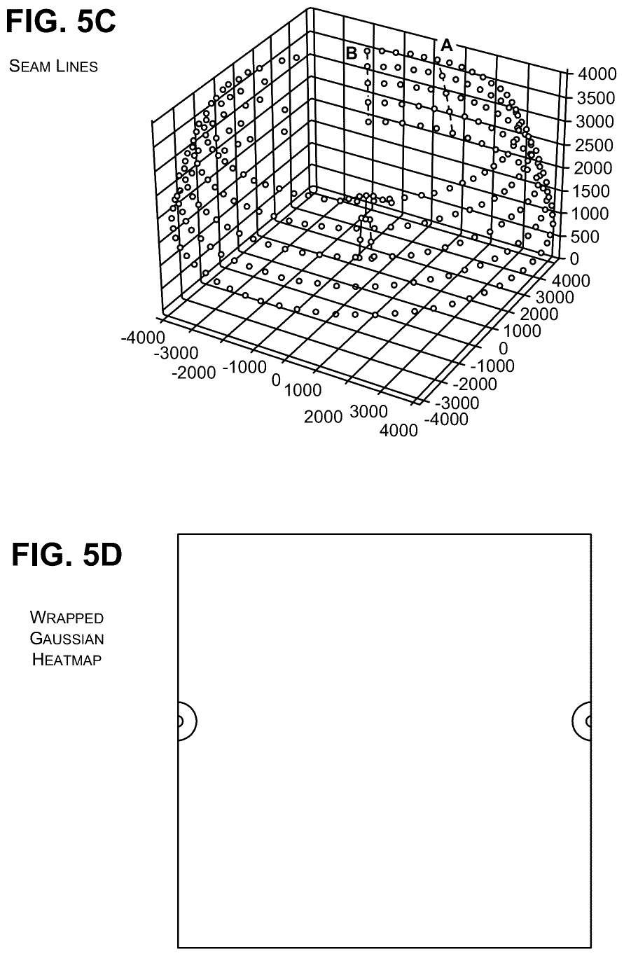

FIG. 5A is a diagram illustrating a naïve approach of encoding a viewpoint, according to some embodiments. FIG. 5A illustrates obtaining an encoding that provides a 1-to-1 mapping from the input image to a relative camera position and learns the spherical mapping of a room. As can be seen in FIG. 5A, for a rotated subject, the same image is present but with different viewpoint encodings. The problem of a naïve approach is illustrated using an encoding azimuth (θ) and elevation (ϕ) of the camera relative to the subject as a Gaussian heatmap on a 2D matrix. FIG. 5A illustrates how two different cameras can generate the same image, resulting in two different viewpoint heatmaps. FIG. 5B is a diagram illustrating a rotation invariant approach of encoding viewpoint, in accordance with some embodiments. Rotation invariant approach produces the same encoding if the image is same even if the subject is rotated. FIG. 5B reflects the improvement from FIG. 5A. Note that, for the same input, the result is the same viewpoint encoding.

The systems and techniques use the concept of wrapping a matrix in a cylindrical formation. The edge where the matrix edges meet is referred to as a seam line. FIG. 5C is a diagram illustrating seam lines after computing cosine distances, in accordance with some embodiments. Camera indices (black=0, white=63), rotate with the subject. Seam line A is the original starting point of the indices. Seam line B is the new starting point consistent with the subject's rotation. Note that an encoding is defined where the seam line is always at the back of the subject and thus opposite to their forward vector. This ensures the coordinates on the matrix always stay in a fixed point related to the subject's orientation. The systems and techniques compute the cosine distance between the subject's forward vector \vec{F}ₛ projected onto xy-plane \vec{F}ₛₚ, and the camera's forward vector \vec{F}_{c} and then place the seam line (index 0 and 63 of the matrix) directly behind the subject.

To learn a spherical mapping, the network is made to understand the spherical positioning of the cameras. Normally, a normal heatmap-based regression will clip the Gaussian at the border of the matrix. However, the systems and techniques allow the Gaussian heatmaps in the matrix to wrap around at the boundaries corresponding to the seam line. Let

$$( x , y , {μ}_{x} , {μ}_{y} ) = {exp}^{- \frac{{( x - {μ}_{x} )}^{2} + {( y - {μ}_{y} )}^{2}}{2 {\text{?}}^{2}}} \qquad 1 )$$

$$\text{?} \text{indicates text missing or illegible when filed}$$

be the formula for a Gaussian value at (x, y) around (μₓ, μ_{y}). Then the heatmap is:

$${ℋ}^{\text{?}} [ i , j ] = \{ \begin{matrix}( j , i , {μ}_{x} , {μ}_{y} ) , & if \vert {μ}_{x} - j \vert < {W}_{k} \\ ( j - {I}_{w} , i , {μ}_{x} , {μ}_{y} ) , & if \vert j - {I}_{w} - {μ}_{x} \vert < {W}_{k} \\ ( j + {I}_{w} , i , {μ}_{x} , {μ}_{y} ) , & if \vert {μ}_{x} - {I}_{w} - j \vert < {W}_{k}\end{matrix} \qquad 2 )$$

$$\text{?} \text{indicates text missing or illegible when filed}$$

where (μₓ, μ_{y}) is the index of the view point in the rotated synthetic room. I_{w} is the image size, and Wₖ is the kernel width. Algorithm 2 below is used to rotate the camera indices in the synthetic room to enable the camera position to be consistent with the subject.

Algorithm 2: Rotate Camera Array

| | |
|---|---|
| Data: | Sₑ (Synthetic Environment), |
| | \vec{F} [symbol] (Subject Forward Vector) |

Result: T′, R′
\vec{F} [symbol] ← Sₑ.camera_forwards;
\vec{F} [symbol] ← \vec{F} [symbol] − (\vec{F} [symbol] · \hat{z})\hat{z};
D ← \vec{F} [symbol] · \vec{F} [symbol] ;
S ← argmax D;
I ← S [symbol] .original_index_array;
Iᵣ ← rotate_index_array(I, S);
T ← Sₑ.camera_position;
R ← Sₑ.camera_rotation;
T′ ← T[Iᵣ];
R′ ← R[Iᵣ];

[symbol]

indicates data missing or illegible when filed

Algorithm 2 encodes the camera position in subject space and the addition of a Gaussian heatmap relaxes the area for the network (AI) to optimize on (e.g., by picking an almost approximate neighboring camera).

### Pose Encoding

The pose is decomposed into bone vectors Bᵣ and bone lengths Bᵣ, both relative to a parent joint. The synthetic environment's selected camera rotation matrix is represented by Rᵢⱼ, and Bᵢⱼ=Rᵢⱼ′ Bᵣ and the bone vectors in Rᵢⱼ's coordinate space. Then, the spherical angles (θ, ϕ) of Bᵢⱼ are normalized from the range [−180, 180] to the range [0, 127]. Note that this encoding is not dependent on any normalization of the training and is therefore also independent of any normalization of the test set. In this way, (θ, ϕ) is normalized in a 128×128 grid. A similar approach to viewpoint encoding is used by allowing the Gaussian heatmap generated around the matrix locations to wrap around the boundaries. The primary difference is in viewpoint and accounting for horizontal warping. Here, both vertical and horizontal wrapping are accounted for. For joint i and k₁, k₂

$$∈ [ - \frac{{W}_{k}}{2} , \frac{{W}_{k}}{2} ] ,$$

$${ℋ}_{i}^{p} [ h , g ] = ( {k}_{1} , {k}_{2} , 0 , 0 ) \qquad 3 )$$

where h=μ_{y}+k₂(mod I_{w}) and g=μ_{y}+k₁(mod I_{w}). Thus, the heatmap-based encoding for the pose is H^{p}∈ [symbol] ^{128×128×N}, where N is the number of joints. FIG. 5D is a diagram illustrating a Gaussian heatmap warped horizontally, in accordance with some embodiments.

### Pose Reconstruction

Because the camera viewpoint is encoded in a subject-based coordinate system, the first step of pose reconstruction is to transform the camera's position from subject-centered coordinates to world coordinates. Assume Ĥ^{v} and Ĥ^{p} are the output of viewpoint and pose network respectively. The non-maxima suppression on Ĥ^{v} yields camera indices (î, ĵ), and spherical angles (\hat{θ}, \hat{ϕ}) from Ĥ^{p}. In an arbitrary synthetic room with an arbitrary seam line, pick a subject forward vector, \vec{F}ₛ parallel to the seam line. Let the rotation matrix of camera at (î,ĵ) relative to \vec{F}ₛ be R_{îĵ}. Obtain the Cartesian unit vectors B_{îĵ}from (\hat{θ}, \hat{ϕ}) and the relative pose in world space by, B_{d}=R_{îĵ}B_{îĵ}. Then, depth first traversal is applied on B_{d}, starting from the origin, to reconstruct the pose using the bone lengths stored in the synthetic environment.

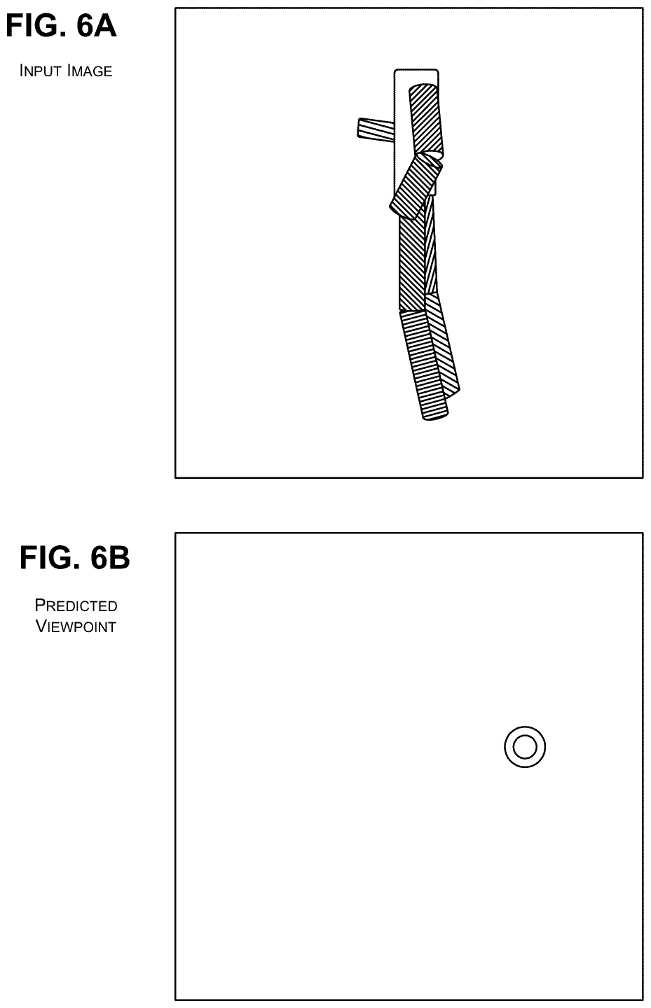

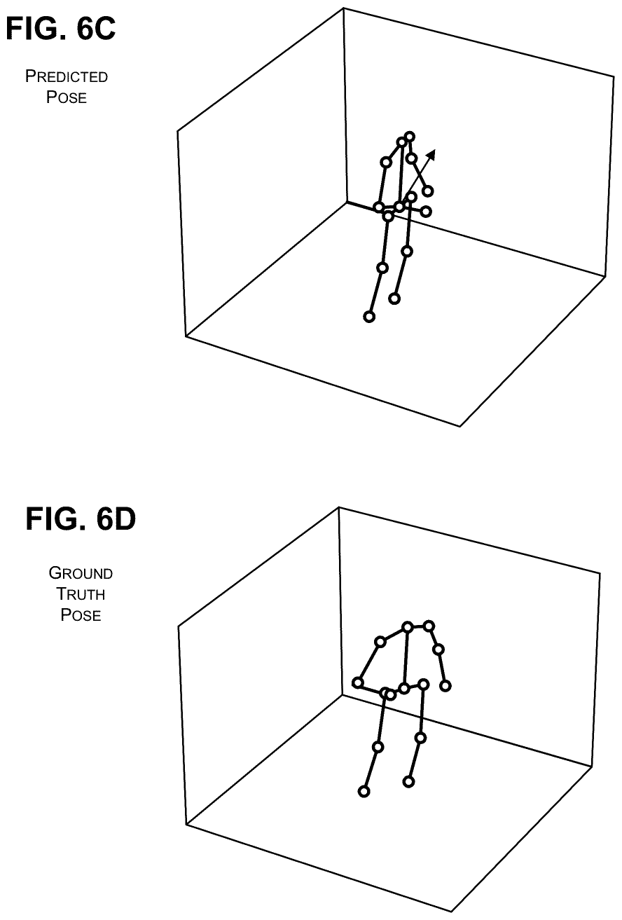

FIGS. 6A, 6B, 6C, 6D illustrate test output from an actual (neural) network (AI). FIG. 6A is a diagram illustrating a synthetic image fed into the human pose recognition network 222(2) of FIG. 2, in accordance with some embodiments. FIG. 6B is a diagram illustrating the predicted viewpoint heatmap 226(1), in accordance with some embodiments. FIG. 6C is a diagram illustrating the reconstructed pose 230 that has is reconstructed from the pose heatmaps 226(2) and the viewpoint heatmap 226(1), in accordance with some embodiments. FIG. 6D is a diagram illustrating a ground-truth 3D pose, in accordance with some embodiments. In FIG. 6C, note how the reconstructed pose is rotated from the ground-truth pose in FIG. 6D. The arrow shooting out from the subject's left in FIG. 6C, indicates the relative position of the camera when the picture was taken. While specific systems and techniques for human pose recognition systems are discussed herein with respect to FIGS. 3A-6D, various other systems and techniques for human pose recognition systems may be utilized in accordance with the systems and techniques described herein.

### Example Implementation

As an experiment, the average bone lengths were calculated from the H36M dataset's training set. The viewpoint was discretized into 24×64 indices and encoded into a 64×64 matrix, corresponding to an angular resolution of 5.625°. The 24 rows span within a [21, 45] row range in the heatmap matrix. In some cases, for example, the viewpoint may be discretized into various parameters such as, but not limited to, a 32×4 indices system encoded into a 64×64 grid within the range. The fixed-point scalar in the synthetic environment was set to 0.4, the radius set to 5569 millimeters (mm). This setup could easily be extended to include cameras covering the entire sphere in order to, for example, account for images of astronauts floating (e.g., in the International Space Stations (ISS)) as viewed from any angle. The pose was first normalized to fall in the range [0, 128] to occupy a 13×128×128 matrix. When using a 14 joint setup, 13 is the number of bones. It should be noted that the systems and techniques described herein can be easily scaled to more joints. The 14 joint setup is used purely as an experimental configuration. A similar network architecture was used for individual networks, because the network architecture was not the primary focus. For all the tasks, we use, as an example, HRNet pretrained on MPII and COCO as a feature extraction module. Of course, any other model pretrained with the same (or different) datasets can be used instead of the HRNet pretrained on MPII and COCO. The numbers described in the example implementation are purely for illustration purposes. It should be understood that other matrix sizes and the like may be used based on the systems and techniques described herein.

We calculate average bone lengths for the H36M training set. The viewpoint is discretized into 24×64 indices, encoded to occupy rows of a 64×64 heatmap matrix, giving angular resolution 5.625°. Our synthetic environment uses fixed point scalar of 0.4, with radius 5569 mm. The pose is normalized to fall into the range [0, 128] to occupy a 13×128×128matrix, with 13 being the number of limbs since we have 14 joints. For simplicity, we followed similar network architecture for all of the networks. We use HRNet pretrained on MPII, and COCO for feature extraction. The “image-to-abstract” network outputs 2D keypoint heatmaps and a binary limb occlusion matrix of dimension 9×9. We keep the original architecture for the 2D pose prediction and add a separate branch with a series of three interleaved convolution and batch normalization block with kernel size 3×3 to reduce the resolution. The reduced output is flattened and passed through two fully connected blocks to output the limb occlusion matrix as an 81D vector. We optimized the mean squared error loss on the 2D heatmaps and binary cross-entropy loss for the limb occlusion matrix. The pose network consists two Convolution and Batch Normalization block pairs, followed by a transposed Convolution to match the output size of 128×128. All the convolution blocks use a 3×3 kernel with padding and stride set to 1. The final transposed convolution uses stride 2 and outputs a 13×128×128 size tensor. For viewpoint estimation, we apply only one Convolution and Batch Normalization pair on the output of HRNet. The final stage is a regular convolution block that shrinks the output channel to 1 and outputs a 1×64×64 size tensor. Since our target is a heatmap, we apply the standard L2 loss. All training used batch size 64, with Adam as the optimizer using Cosine Annealing with warm restart and a learning rate warming from 1×10-9 to 1×10-3The viewpoint network ran for 200 epochs (2 days), and the pose network ran for 300 epochs (4 days), both on an RTX 3090, though it was stopped early due to convergence. When training the “abstract to pose and viewpoint” network, on every epoch we pick a random set of camera indices and render an abstract image from one of the two variants with equal probability. Thus, no two epochs are the same. This randomness minimizes overfitting—in turn helping with generalization—though it results in longer time-to-convergence.

### Experiments

Datasets. Human3.6M Dataset (H36M) includes 15 actions performed 7 actors in a 4 camera setup. In the experiment, take the 3D pose in world coordinate space to train the network. A standard protocol may be followed by keeping subject 1, 5, 6, 7, 8 for training, and 9, 11 for testing. S Geometric Pose Affordance Dataset (GPA) that has 13 actors interacting with a rich 3D environment and performing numerous actions is used for cross-dataset testing. 3D Poses in the Wild Dataset is an “in-the-wild” dataset with complicated poses and camera angles that is used for cross-dataset testing. The SURREAL Dataset is one of the largest synthetic datasets with renderings of photorealistic humans (“robots”) and is used for cross-dataset testing.

Evaluation Metrics: Mean Per Joint Position Error (MPJPE) in millimeters, is referred to as Protocol #1 and MPJPE after Procrustes Alignment (PA-MPJPE) is referred to as Protocol #2, following convention. Since the reconstructed pose is related with the ground truth by rotation, it is reported under Protocol #1. Further, PA-MPJPE reduces the error because the reconstruction uses preset bone-lengths, which becomes prominent in cross-dataset benchmarks.

Evaluation on H36M Dataset: Training uses a dataset of 3D poses taken from the H36M dataset. At training time, on each iteration, the poses may be paired with a random sample of viewpoints from a synthetic environment to generate synthetic images. A camera from the H36M dataset is not used during training. In testing, the camera configuration provided with the dataset to generate test images is used. The results are shown in Table 1 and Table 2 and show how the systems and techniques outperform conventional systems in all actions except “Sitting Down” and “Walk.” Specifically, “Sitting Down” is still a challenging task for the viewpoint encoding scheme because it relies on the projection of the forward vector. Leveraging a joint representation of spine and forward (which are orthogonal to each other) may improve the encoding. During reconstruction, a preset bone-length is used. PA-MPJPE score on Table 2, which includes rigid transformation, accounts for bone-length variation and reduces the error even more.

TABLE 1

| Method | Dir. | Disc. | Eat | Greet | Phone | Photo | Pose | Purch, | Sit | SitD. | Smoke | Wait | WalkD. | Walk | WalkT. | Avg. |
|---|---|---|---|---|---|---|---|---|---|---|---|---|---|---|---|---|
| Moreno [24] | 69.6 | 80.1 | 78.2 | 87 | 100.7 | 1.02.7 | 76 | 69.6 | 104.7 | 113.9 | 89.7 | 98.5 | 79.2 | 82.4 | 77.2 | 87.3 |
| Chen [4] | 71.8 | 66.6 | 74.7 | 79.1 | 70.1 | 98.3 | 67.6 | 89.3 | 90.7 | 195.8 | 88.8 | 71.3 | 85.0 | 65.7 | 02.6 | 82.7 |
| Martinez [23] | 51.8 | $6.2 | 58.1 | 59 | 69.5 | 78.4 | 55.2 | 58.1 | 74 | 94.6 | 62.8 | 59.1 | 65.1 | 49.5 | 62.4 | 62,9 |
| Yang [ ] | 51.5 | 68.9 | 50.4 | 57 | 62.1 | 05.4 | 49.8 | 52.7 | 69.2 | 85.2 | 57.4 | 88.4 | 43.0 | 60.1 | $7.7 | 58.0 |
| Sharma [28] | 48.6 | 84.5 | 4.2 | 55.7 | 62.6 | 72 | 60.8 | 54.3 | 70 | 78.3 | 58.1 | 56.4 | 61.4 | 46.2 | 49.7 | 58 |
| Zhao [42] | 47.3 | 60.7 | 51.4 | 60.8 | 81.1 | 49.9 | 47.3 | 08.1 | 86.2 | 55 | 87.8 | 81 | 42.1 | 00.6 | 45.3 | 57.0 |
| Pavlakos [29] | 48.8 | 04.4 | 54.4 | 52 | 59.4 | 86.3 | 49.9 | 52.9 | 08.8 | 71.1 | 56.6 | 52.9 | 60.9 | 44.7 | 47.8 | 66.2 |
| Ci [γ] | 46.8 | 62.3 | 44.7 | 50.4 | 52.9 | 88.9 | 49.6 | 46.4 | 60.2 | 78.9 | 51.2 | 50 | 54.8 | 40.4 | 48.3 | 52.7 |
| Li [15] | 43.8 | 48.0 | 49.1 | 49.8 | $7.6 | 81.5 | 45.9 | 48.3 | 62 | 73.4 | 54.8 | 50.6 | 56 | 43.4 | 45.5 | 82.7 |
| Martinez | 87.7 | 44.4 | 40.3 | 42.1 | 48.2 | 54.9 | 44.4 | 42.1 | 54.6 | | 45.1 | 46.4 | 47.0 | 36.4 | $0.4 | 46.5 |
| Zhao [2] | 37.8 | 49.4 | 37.8 | 40.0 | 45.1 | 41.4 | 40.1 | 48.3 | 50.3 | 43.2 | 53.5 | 44.8 | 40.5 | 47.8 | 39 | 43.8 |
| Zhou faz | 34.4. | 42.4 | 38.0 | 42.1 | 38.2 | 39.8 | 34.7 | 40.2 | 45.8 | 60.8 | 39 | 42.6 | 42 | 29.8 | 31.7 | 39.9 |
| Gong fu | — | — | — | — | — | — | — | — | — | — | — | — | — | — | — | 38.2 |
| Zhas Kol* | 31.3 | 34.0 | 28.0 | 32.0 | 33.1. | 42.1 | 34.1 | 28.1 | 33.6 | 39.8 | 31.7 | 32.9 | 33.8 | 26.7 | 28.9 | 32.7 |
| Ours (Hybrid) | 40.7 | 52.1 | 43.8 | 48.2 | 46.9 | 84.4 | 49.1 | 51.4 | 58.6 | 65.2 | 47 | 49.5 | 44.1 | 42.1 | $2.3 | 48.8 |
| Ours (Cube) | 29.0 | 32.6 | 29.1 | 32.0 | 29.9 | 38.8 | 32.1 | 32.5 | 38.7 | 49.5 | 33.2 | 33.7 | 32.1 | 29.9 | 29.9 | 33.5 |

Table 1: Quantitative comparisions of MPJPE (Protocol #1) between the ground

truth 3D pose and reconstructed 3D pose. Our method shows competitive performance when image is used as an input. Hybrid abstract-to-pose model is trained on mixed
   Flat and Cube abstract images. Note: we have marked the results of others, obtained from ground truth 2D keypoints, with an asterisk. “Ours” refers to the systems and techniques described herein.

TABLE 2

| Method | Dir. | Disc. | Bat | Greet | Phone | Photo | Pose | Purch. | Sh | SRD. | Smoke | Wait | WalkD. | Walk | Walk T. | Avg. |
|---|---|---|---|---|---|---|---|---|---|---|---|---|---|---|---|---|
| Moreno [24] | 66.1 | 61.7 | 84.5 | 73.7 | 65.2 | 67.2 | 60.9 | 67.3 | 103.5 | 74.6 | 92.8 | 39.6 | 71.5 | 78 | 73.2 | 74 |
| Martinez [22] | 39.5 | 43.2 | 46.4 | 47 | 51 | 86 | 41.4 | 40.6 | 56.5 | 69,4 | 49.2 | 45 | 49.5 | 38 | 43.1 | 47.7 |
| Li [15] | 33.5 | 39.8 | 41.3 | 42.3 | 46 | 48.9 | 36.9 | 37.3 | 61 | 60.6 | $4.8 | 40.2 | 44.1 | 33.3 | 30.9 | 42.0 |
| Ci [γ] | 36.9 | 41.6 | 38 | 41 | 41.9 | $1.1 | 38 2 | 37.6 | 49.1 | 62.1 | 48.1 | 89.9 | 43.8 | 32.2 | 37 | 42.2 |
| Pavlakos [25] | 34.7 | 39.8 | 41.8 | 38.6 | 42,5 | 47.5 | 38 | 36.6 | 50.7 | 50.8 | 42.6 | 39.6 | 43.9 | 82.1 | 36.5 | 41.8 |
| Sharma [23] | 85.3 | 38.9 | 45.8 | 42 | 40.9 | 52.6 | 38.9 | 38.8 | 43.5 | 51.0 | $4.3 | 88.8 | 45.8 | 29.4 | 34.3 | 40.9 |
| Zhou [3] | 21.6 | 27 | 20,7 | 28.3 | 27.3 | 32.1 | 23.5 | 30.3 | 30 | 37.7 | 30.1 | 25.3 | 34.2 | 19.2 | 23.2 | 27.9 |
| Ours (Hybrid) | 32.8 | 38.0 | 35.3 | 38.2 | 38.1 | 44.8 | 37.9 | 37.9 | 47.1 | 59.4 | 40.4 | 39.7 | 38.1 | 33.3 | 34.4 | 39.7 |
| Ours (Cube) | 23.8 | 27.6 | 26.5 | 27.1 | 26.1 | 34.8 | 27.0 | 28.7 | 34.4. | 46.8 | 28.9 | 29.0 | 28.4 | 24.4 | 23.9 | 29.1 |

Table 2: Quantitative comparison of PA-MPJPE (Protocol #2) between the ground truth 3D pose and reconstructed 3D pose. We follow the same notation as Tab. 1.

Lower is better. “Ours” refers to the systems and techniques described herein.

Cross-Dataset Generalization: Cross-dataset analysis is performed on two prior datasets that are chosen based on availability and adaptability of their code. Both of these use z-score normalization. The result presented for these two datasets are z-scores normalized with testing set mean and standard deviation, which gives them an unfair advantage. Even after that, the systems and techniques described herein still take the lead in cross-dataset performance as shown by the results in MPJPE in Table 3.

The primary focus is improving cross-dataset performance through extensive training on synthetically generated images. For this experiment, consider the case where we train on H36M dataset without domain adaptation training. To test generalization capabilities, we render the images from GPA, 3DPW, and SURREAL dataset. We report results obtained from all three variants of our models. Our method leads conventional techniques by 30%-40% in cross-dataset performance (see Table 3). As shown in Tables 3, we outperform the other methods by about a factor of 2. We choose to report all the results both obtained through GT 2D keypoints and images, because cross-dataset results are hard to obtain.

TABLE 3
Cross-Dataset results on GPA, 3DPW, SURREAL in MPJPE.

| | MPJPE | | | | PA-MPJPE | | |
|---|---|---|---|---|---|---|---|
| Method | H36M | GPA | 3DPW | SURR. | GPA | 3DPW | SURR. |
| Martinez [23]* | 55.52 | 117.37 | 135.53 | 108.63 | | | |
| Zhao [48]* | 53.59 | 115.01 | 154.3 | 103.75 | | | |
| Wang [39] | 52 | 98.3 | 124.2 | 114 | | | |
| Goel [9] (H36M + 3DHP Training) | 44.8 | — | 70.0 | — | | | |
| Zhao [45] | | | | | — | 152.3 | — |
| Martinez [23] | | | | | — | 145.2 | — |
| ST-GCN [3] (1-Frame) | | | | | — | 154.3 | — |
| VPose [28] (1-Frame) | | | | | — | 146.3 | — |
| Zhao + Gong [10] | | | | | — | 140 | — |
| Martinez + Gong [10] | | | | | — | 130.3 | — |
| ST-GCN (1-Frame) + Gong [10] | | | | | — | 129.7 | — |
| VPose (1-Frame) + Gong [10] | | | | | — | 129.7 | — |
| Goel [9] | | | | | — | 44.5 | — |
| Ours (Hybrid) | 40.01 | 99.43 | 106.27 | 80.13 | 70.1 | 71.39 | 59.06 |
| Ours (Cube) | 33.52 | 92.31 | 95.83 | 65.62 | 69.48 | 64.28 | 51.53 |

The systems and techniques take the lead across the board.
Asterisk marks with reference to the experiment described above.
Note:
the networks were trained on H36M.
“Ours” refers to the systems and techniques described herein.

Gong et al. reported cross-dataset performance on the 3DPW dataset in PA-MPJPE. In Table 4, their result is included for comparison. Again, the systems and techniques outperform the their results by a significant margin. The PA-MPJPE score accounts for bone length discrepancy among datasets and reports a much lower error in GPA, 3DPW, and SURREAL datasets compared to their MPJPE counterpart.

### Qualitative Results

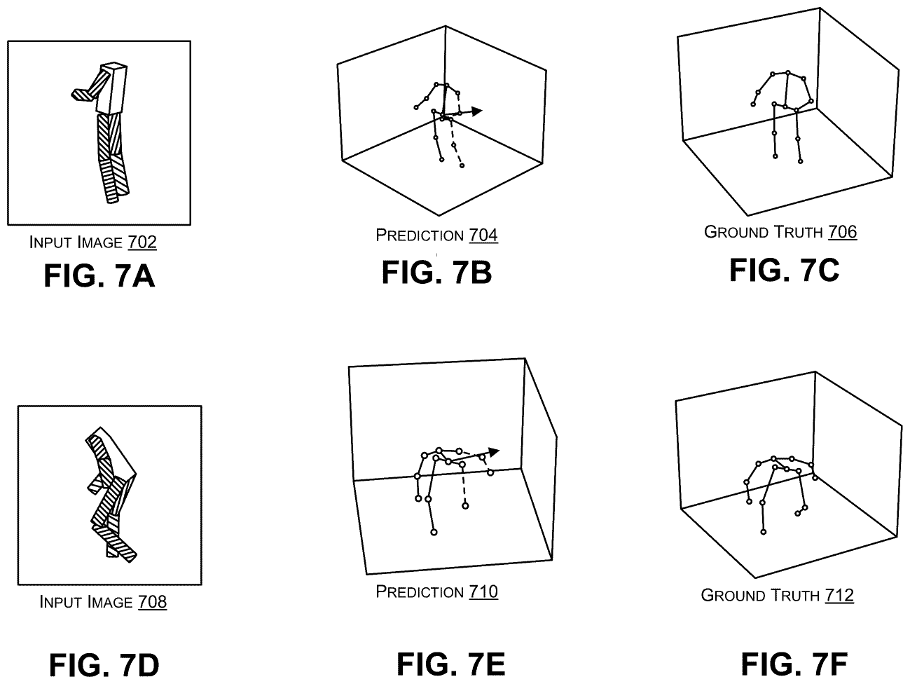

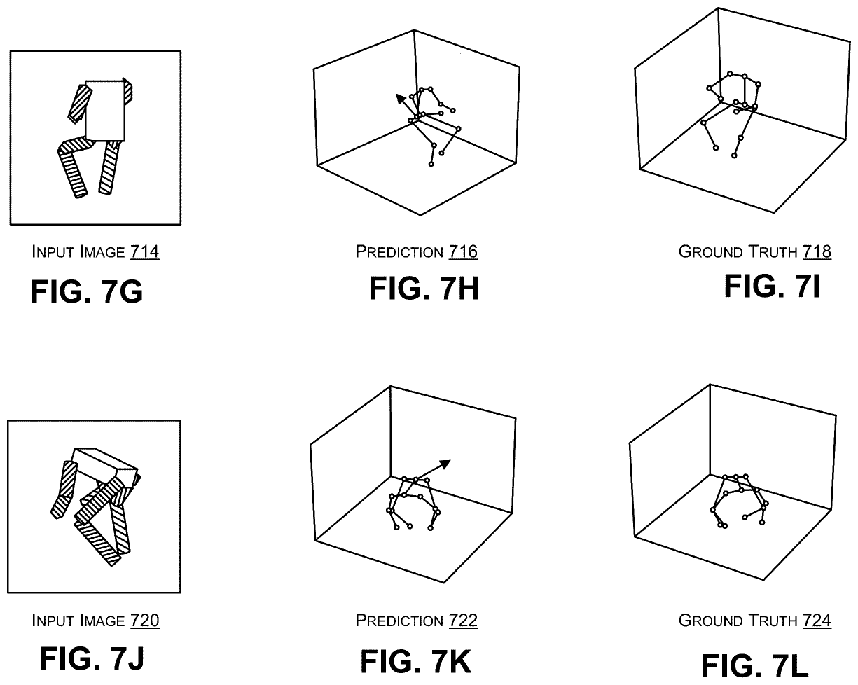

FIGS. 7A, 7B, 7C, 7D, 7E, 7F, 7G, 7H, 7I, 7J, 7K, and 7L illustrate the qualitative performance of the network on H36M. FIGS. 7A, 7B, 7C are diagrams illustrating an input image 702, a prediction 704, and a ground truth 706, respectively, in accordance with some embodiments. FIGS. 7D, 7E, 7F are diagrams illustrating an input image 708, a prediction 710, and a ground truth 712, respectively, of a second abstract in accordance with an embodiment of the invention. FIGS. 7G, 7H, 7I are diagrams illustrating an input image 714, a prediction 716, a ground truth 718, respectively, in accordance with some embodiments. FIGS. 7J, 7K, 7L are diagrams illustrating an input image 720, a prediction 722, a ground truth 724, respectively, in accordance with some embodiments. Note that the arrow indicator (FIGS. 7H, 7K) shows the relative camera position from which the image was taken, illustrating the accurate viewpoint estimation indicated by the arrow in FIGS. 7H, 7K, and showing the accuracy and efficacy of the systems and techniques when detangling viewpoint from pose. Although specific experiments and results of human pose recognition systems is discussed above with respect to FIGS. 7A-L, various experiments and systems and techniques of human pose recognition systems may be used in accordance with the embodiments described herein. Considerations in generating synthetic images in accordance with systems and techniques are further described below.

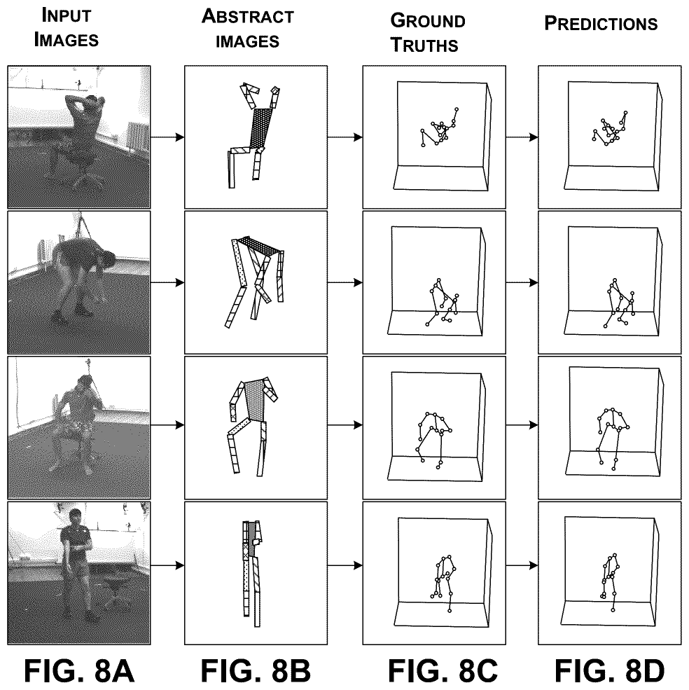

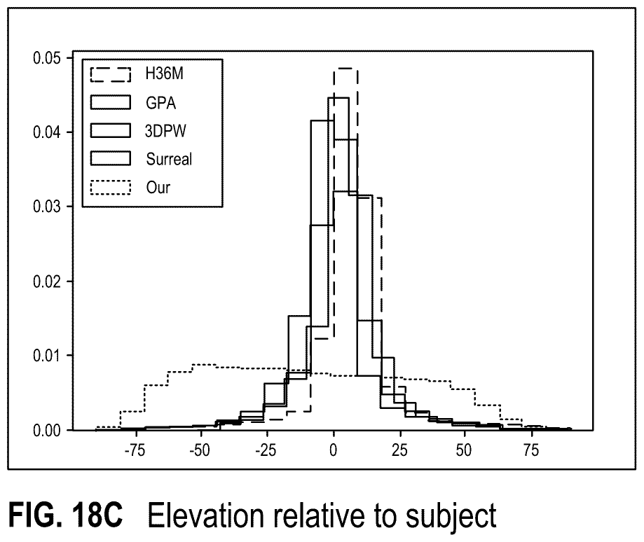

FIGS. 8A, 8B, 8C, 8D show the qualitative performance of our network on H36M. We see viewpoint estimation indicated on the second column of each test sample. This shows the accuracy and efficacy of our method on separating viewpoint from pose. Our synthetic environment has hundreds of cameras placed systematically in “levels” on the sphere, pointing inwards. For this study, we reduced the number of levels. Intuitively, decreasing the number of levels should reduce performance, which is what we see. Increase in number of vertical bins shows a global improvement in cross-dataset performance in FIG. 18A. In FIGS. 18B and 18C, we have plotted the azimuth and elevation distribution across all datasets, demonstrating the generalization and augmentation ability of our approach. Notice how our approach that relies on random viewpoints, have an almost uniform distribution. In contrast, notice how majority of the datasets have more data points distributed at the level of the subject. Angular Error vs Bin Size With an Ng×Ng heatmap, we expect performance to decrease with decreasing Ng. From our experiments, the angular error goes up as we decrease the grid resolution. We see the biggest jump from 16×16 (13.35°) to 32×32 (9.24°) with a smaller change when going to 64×64 (8.44°), implying diminishing returns at higher resolutions. For limb ablation, we randomly skip rendering a subset of the limbs, causing an expected increase in error and uncertainty (cf. FIG. 8a). Variation in Reconstruction Scale For this experiment, we change the bone lengths that are used to reconstruct the pose, deviating 50% scale up and down from the average bone lengths of an adult person. When comparing we keep the ground-truth at default scale (cf. FIG. 8b. Obviously, the reconstructed pose will not match in scale and the error will increase when deviating from the average bone lengths. However, at the bottom of the V-shaped curve the error deviation is small—which means, if the subject scale varies by a small amount, the error is negligible. As Procrustes alignment is performed first before measuring the error in PA-MPJPE, the curve forms a straight line and stays below the V curve. Effect of wrapping on Error We observe the impact of wrapping on the error by computing pose estimation error on all the actions of H36M dataset with and without wrapping enabled. As can be seen in FIG. 8c), we achieve an average of 9.4 mm of improvement—from 58.2 mm (red) to 48.8 mm (blue). In addition, when we toggle wrapping in predicting viewpoint (i.e. naïve vs our viewpoint encoding), we see an angular errors are respectively 55.44° vs. 8.44°—an improvement factor of 6.6.

### Considerations When Generating Synthetic Images

In some cases, a Generative Adversarial Neural Network (GANN) may be trained using such a setup. In addition to the traditional GAN loss function, the systems and techniques add an L1 loss function 810 following the pix2pix implementation. In some cases, the network is trained for 200 epochs using an Adam optimizer with a learning rate 0.0002. An L1 Loss Function is used to minimize the error which is determined as the sum of the all the absolute differences between the true value and the predicted value. An L2 Loss Function is used to minimize the error which is the sum of the all the squared differences between the true value and the predicted value.

Robustness of Abstract-to-Pose: To improve robustness of the abstract-to-pose, several different augmentation strategies may be used. Notably, Perlin noise may be applied to the synthetic image. After applying a binary threshold to the noise image, it is multiplied with the synthetic image, before feeding it to the network. This introduces granular missing patches in the images of an almost natural shape.

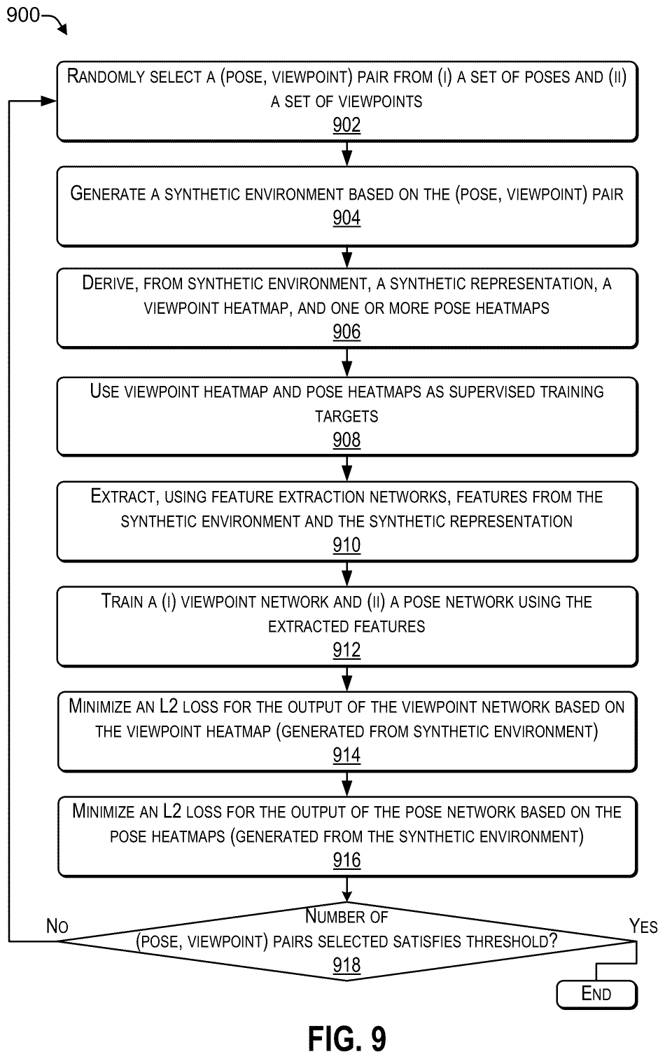

In the flow diagram of FIGS. 9, 10, 11, 12, 13, 14, 15, 16, and 17, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 900, 1000, 1100, 1200, 1300, 1400, 1500, 1600, and 1700 are described with reference to FIGS. 1, 2, 3, 4, 5A-B, 6A-D, 7A-L, and 8A-B, as described above, although it should be understood that other models, frameworks, systems and environments may be used to implement these processes.

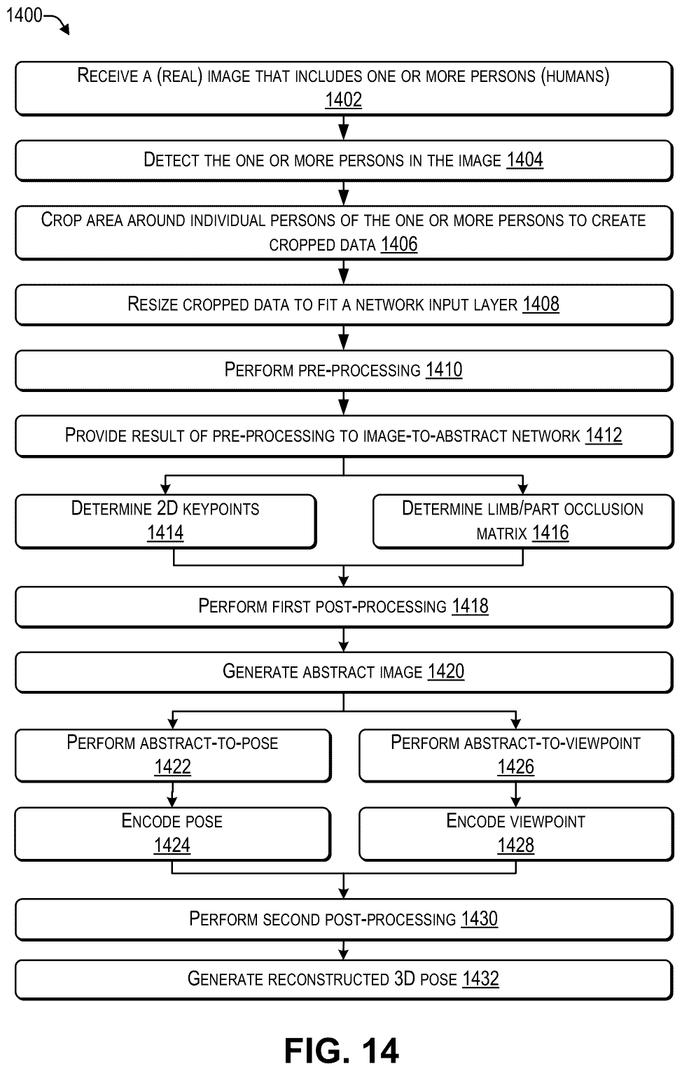

FIG. 9 is a flowchart of a process 900 that includes training a viewpoint network and a pose network, according to some embodiments. The process may be performed by one or more of the components illustrated in FIG. 2 and/or by the computing device 1400 of FIG. 14. In some cases, the process may be performed during a training phase, such as the training phase 202 of FIG. 2.

At 902, the process may randomly select a (pose, viewpoint) pair from a set of poses and a set of viewpoints (e.g., the pose selected from set of poses and the viewpoint selected from the set of viewpoints). At 904, the process may generate a synthetic environment based on the (pose, viewpoint) pair. At 906, the process may derive, from the synthetic environment, an abstract representation, a viewpoint heatmap, and one or more pose heatmaps. At 908, the process may use the viewpoint heatmap and the pose heatmaps as supervised training targets. At 910, the process may extract, using extra feature extraction networks, features from the synthetic environment and from the abstract representation. At 912, the process may train a viewpoint network and pose network using the extracted features. At 914, the process may minimize an L2 loss function for the output of the viewpoint network based on the viewpoint heatmap (generated from the synthetic environment). At 916, the process may minimize an L2 loss function for the output of the pose network based on the pose heatmaps (generated from the synthetic environment). At 918, the process may determine whether a number of (pose, viewpoint) pairs selected satisfies a determined threshold. If the process determines, at 918, that the number of (pose, viewpoint) pairs selected satisfies the predetermined threshold, then the process may end. If the process determines, at 918, that the number of (pose, viewpoint) pairs selected fails to satisfy the predetermined threshold, then the process may go back to 902 to select an additional (pose, viewpoint) pair. In this way, the process may repeat 902, 904, 906, 908, 910, 912, 914, and 916 until the number of (pose, viewpoint) pairs that have been selected satisfy the predetermined threshold.

For example, in FIG. 2, a representative randomly selected 3D pose 204 and a representative randomly selected viewpoint 206 are used to generate a synthetic environment 208 from which are derived an abstract representation 210, a viewpoint heatmap 212, and pose heatmaps 214. The viewpoint heatmap 212 and pose heatmaps 214 are used as supervised training targets. Backbone feature extraction (neural) network 218(1), 218(2) may be used to extract features 220(1), 220(2) to train a viewpoint (neural) network 222(1) and a pose (neural) network 222(2), respectively. For example, the feature extraction networks 218(1), 218(2) take as input the synthetic environment 208, extract features 220(1), 220(2), and feed the extracted features 220(1), 220(2) to the viewpoint network 222(1) and the pose network 222(2), respectively. An L2 loss 224(1) is optimized (minimized) for the output of the viewpoint network 222(1) based on the viewpoint heatmap 212 generated from the synthetic environment 208 and an L2 loss 224(2) is optimized (minimized) for the output of the pose network 222(2) based on the pose heatmaps 214 generated from the synthetic environment 208. The L2 loss 224(1), 224(2) are also known as Squared Error Loss, and are determined using the squared difference between a prediction and the actual value, calculated for each example in the dataset. The aggregation of all these loss values is called the cost function, where the cost function for L2 is commonly MSE (Mean of Squared Errors).

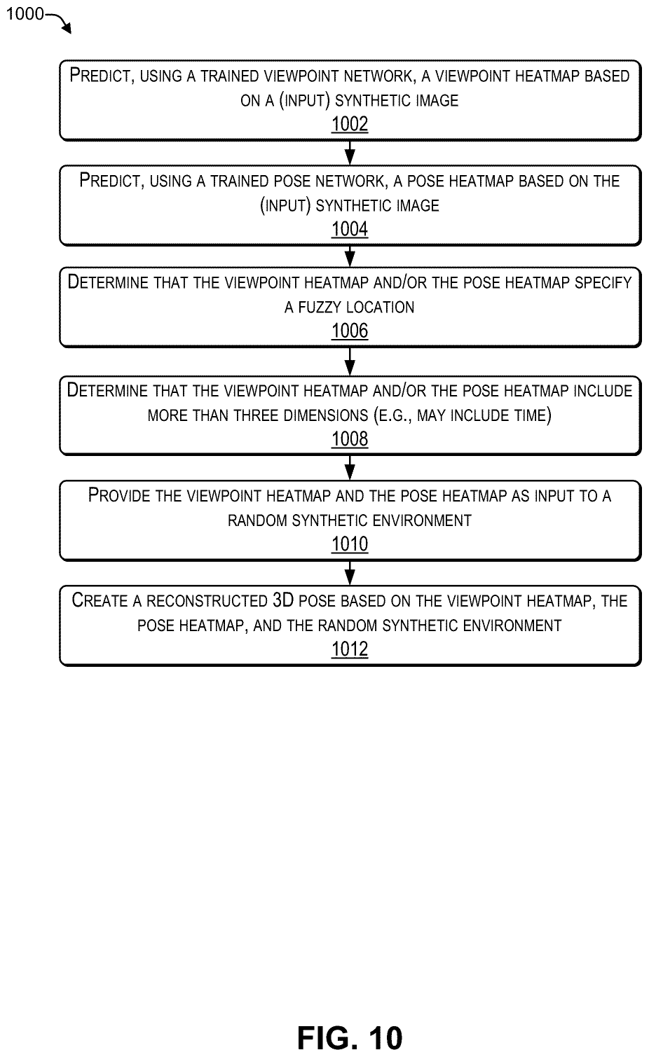

FIG. 10 is a flowchart of a process 1000 that includes creating a reconstructed 3D pose based on a viewpoint heatmap, a pose heatmap, and a random synthetic environment, according to some embodiments. The process may be performed by one or more of the components illustrated in FIG. 2 and/or by the computing device 1400 of FIG. 14. In some cases, the process may be performed during a reconstruction (inference) phase, such as the reconstruction phase 203 of FIG. 2.

At 1002, the process may use a trained viewpoint network to predict a viewpoint heatmap based on a (input) synthetic image. At 1004, the process may predict a pose heatmap based on the (input) synthetic image. At 1006, the process may determine that the viewpoint heatmap and/or the pose heatmap specify a fuzzy location. At 1008, the process may determine that the viewpoint heatmap and/or the pose heatmap include more than three dimensions (EG, may include time etc.). At 1010, the process may provide the viewpoint heatmap and the pose heatmap as input to a random synthetic environment. At 1012, the process may create a reconstructed 3-D pose based on the viewpoint heatmap, the pose heatmap, and the random synthetic environment.

For example, in FIG. 2, the trained viewpoint network 222(1) may take synthetic images as input and generate (predict) a viewpoint heatmap 226(1). The trained pose network 222(2) may take synthetic images as input and generate (predict) a pose heatmap 226(2). The heatmaps 226(1), 226(2) are passed into a random synthetic environment 228 to create reconstructed image data 229 that includes a reconstructed 3D pose 230. In some cases, the heatmaps 226 may include a location map or a “fuzzy” map. In some cases, the heatmaps 226 may specify a fuzzy location and may represent only one possible fuzzy location. In some cases, the heatmaps 226 may take a shape in any number of dimensions (e.g., 2D, 3D, 4D, etc.). For example, if the systems and techniques are used for video, the heatmaps 226 include time as an added dimension, thus making the heatmaps 226 at least 3D.

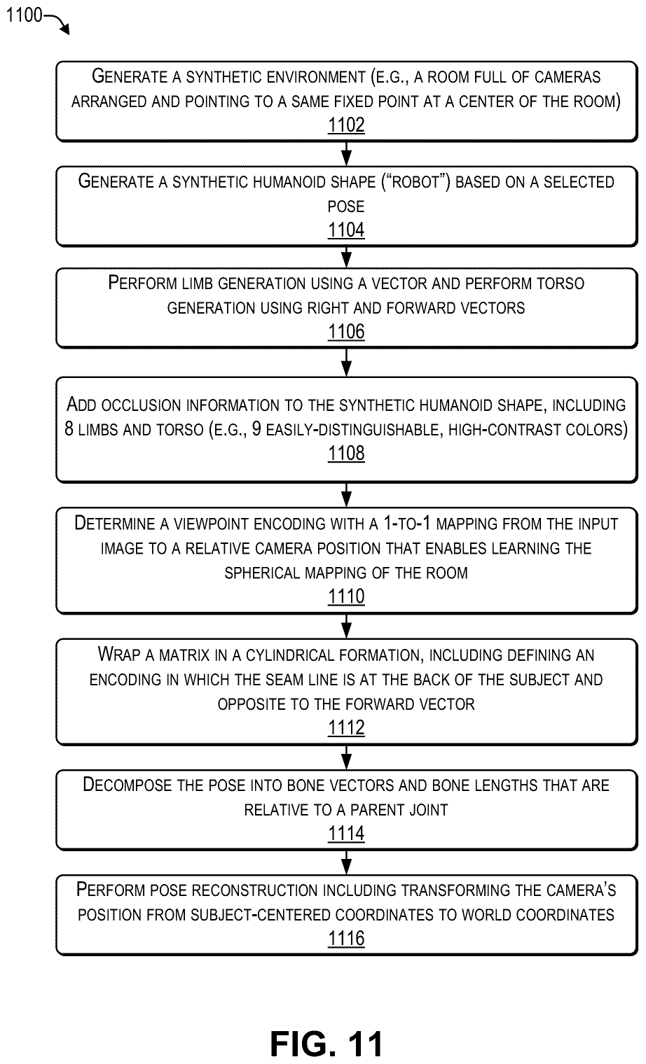

FIG. 11 is a flowchart of a process 1100 that includes performing pose reconstruction and transforming a camera's position from subject-centered coordinates to world coordinates, according to some embodiments. The process may be performed by one or more of the components illustrated in FIG. 2 and/or by the computing device 1400 of FIG. 14.

At 1102, the process may generate a synthetic environment (e.g., a room full of cameras arranged in pointing to a same fixed point at a center of the room). For example, in FIG. 3A, the synthetic environment 208 includes a room 302 with multiple cameras 304 arranged spherically and pointing to a same fixed point 306 at the center of the room 302

At 1104, the process may generate a synthetic humanoid shape (“robot”) based on a selected pose. For example, in FIG. 3B, to provide occlusion information associated with the synthetic images used in the training data, the abstract image 210 (“robot”) has 8 limbs and torso that may be represented using 9 easily distinguishable, high-contrast colors (or different types of shading, as shown in FIG. 3B). For example, if left forearm 308 and femur 310 are colored blue, then the AI can easily determine where the abstract (image) representation 210 is facing.

At 1106, the process may perform limb generation using a vector and perform torso generation using right and forward vectors. For example, in FIG. 4A, 4B, 8 limbs and a torso may be formed by cuboids with orthogonal edges formed via appropriate cross-products. A limb 402 in FIG. 4A has a long axis (a to b) along a bone with a square cross-section. A torso 404 in FIG. 4B is longest along the spine and has a rectangular cross-section. While the limb cuboid in FIG. 4A may be generated from a single vector (a to b), the torso 404 in FIG. 4B may be generated with the help of a body centered coordinate system. In FIG. 5B, c represents Camera indices (black=0, white=63), rotate with the subject. Seam line A is the original starting point of the indices. Seam line B is the new starting point consistent with the subject's rotation. Note that an encoding is defined where the seam line is always at the back of the subject and thus opposite to their forward vector. This ensures the coordinates on the matrix always stay in a fixed point related to the subject's orientation. The systems and techniques compute the cosine distance between the subject's forward vector F^{→}_s projected onto xy-plane F^{→}_sp, and the camera's forward vector F^{→}_c and then place the seam line (index 0 and 63 of the matrix) directly behind the subject.

At 1108, the process may add occlusion information to the synthetic humanoid shape, including occlusion information for eight limbs and a torso (e.g., nine easily distinguishable high contrast colors or shadings). For example, in FIG. 3B, to provide occlusion information associated with the synthetic images used in the training data, the abstract image 210 (“robot”) has 8 limbs and torso that may be represented using 9 easily distinguishable, high-contrast colors (or different types of shading, as shown in FIG. 3B).

At 1110, the process may determine a viewpoint encoding with a 1:1 mapping from the input image to a relative camera position that enables learning the spherical mapping of the room. In FIG. 5A, an encoding is obtained to provide a 1-to-1 mapping from the input image to a relative camera position and learns the spherical mapping of a room. As can be seen in FIG. 5A, for a rotated subject, the same image is present but with different viewpoint encodings. The problem of a naïve approach is illustrated using an encoding azimuth (θ) and elevation (ϕ) of the camera relative to the subject as a Gaussian heatmap on a 2D matrix.

At 1112, the process may wrap a matrix in a cylindrical formation, including defining an encoding in which the seam line is at the back of the subject and opposite to the forward vector. For example, in FIG. 5B, camera indices (black=0, white=63), rotate with the subject. Seam line A is the original starting point of the indices. Seam line B is the new starting point consistent with the subject's rotation. Note that an encoding is defined where the seam line is always at the back of the subject and thus opposite to their forward vector.

At 1114, the process may decompose the pose into bone vectors and bone lengths that are relative to a parent joint. For example, in FIG. 5C, the pose is decomposed into bone vectors Bᵣ and bone lengths Bᵣ, both relative to a parent joint. The synthetic environment's selected camera rotation matrix is represented by Rᵢⱼ, and Bᵢⱼ=Rᵢⱼ′ Bᵣ and the bone vectors in Rᵢⱼ's coordinate space. Then, the spherical angles (θ, ϕ) of Bᵢⱼ are normalized from the range [−180, 180] to the range [0, 127]. Note that this encoding is not dependent on any normalization of the training and is therefore also independent of any normalization of the test set. In this way, (θ, ϕ) is normalized in a 128×128 grid. A similar approach to viewpoint encoding is used by allowing the Gaussian heatmap generated around the matrix locations to wrap around the boundaries. The primary difference is in viewpoint and accounting for horizontal warping. Here, both vertical and horizontal wrapping are accounted for.

At 1116, the process may perform pose reconstruction, including transforming the camera's position from subject centered coordinates to world coordinates. For example, in FIG. 5C, because the camera viewpoint is encoded in a subject-based coordinate system, the first step of pose reconstruction is to transform the camera's position from subject-centered coordinates to world coordinates. Assume Ĥ^{v} and Ĥ^{p} are the output of viewpoint and pose network respectively. The non-maxima suppression on Ĥ^{v} yields camera indices (î, ĵ), and spherical angles (\hat{θ}, \hat{ϕ}) from Ĥ^{p}. In an arbitrary synthetic room with an arbitrary seam line, pick a subject forward vector, \vec{F}ₛ parallel to the seam line. Let the rotation matrix of camera at (î, ĵ) relative to \vec{F}ₛ be R_{îĵ}. Obtain the Cartesian unit vectors B_{îĵ}from (\hat{θ}, \hat{ϕ}) and the relative pose in world space by, B_{d}=R_{îĵ}B_{îĵ}. Then, depth first traversal is applied on B_{d}, starting from the origin, to reconstruct the pose using the bone lengths stored in the synthetic environment.

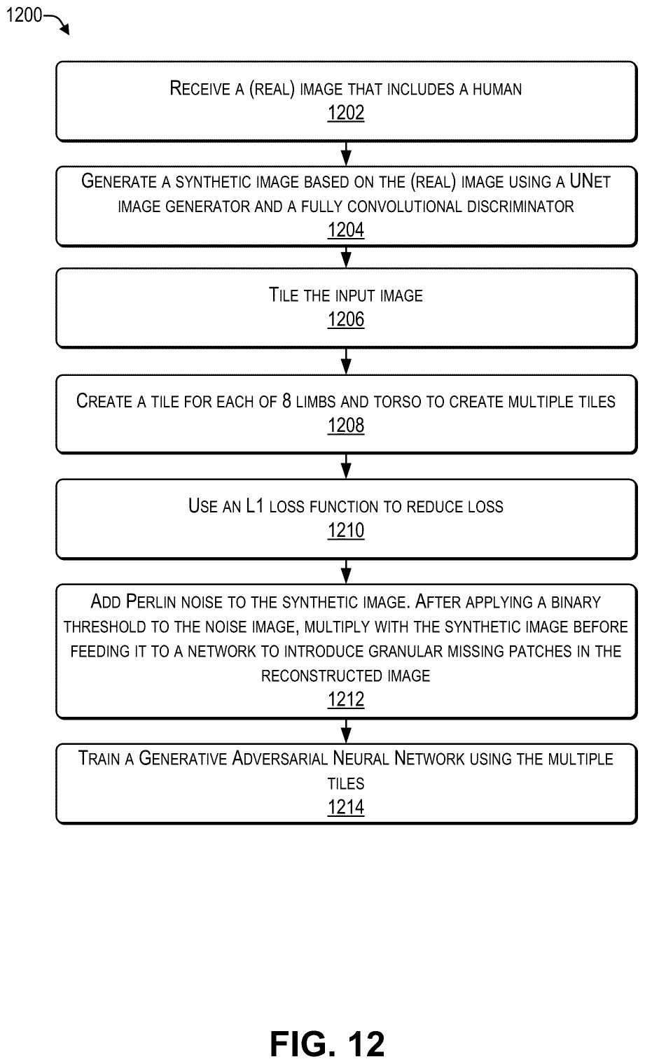

FIG. 12 is a flowchart of a process 1200 that includes training a generative adversarial neural network using multiple tiles, according to some embodiments. The process may be performed by one or more of the components illustrated in FIG. 2 and/or by the computing device 1400 of FIG. 14.

At 1202, the process may receive a real image (e.g., photograph or frame from a video) that includes a human in a human pose. At 1204, the process may generate a synthetic image based on the real image using a UNet (a type of convolutional neural network) image generator and a fully convolutional discriminator. At 1206, the process may tile the input image. At 1208, the process may create a tile for each of eight limbs and a torso (of the pose) to create multiple tiles. At 1210, and L1 loss function may be used to reduce loss. At 1212, Perlin noise may be added to the synthetic image. After applying a binary threshold to the noise image, the Perlin noise may be multiplied with the synthetic image before feeding it to a network to introduce granular missing patches in the reconstructed image. At 1214, the process may train a generative adversarial neural network using the multiple tiles.

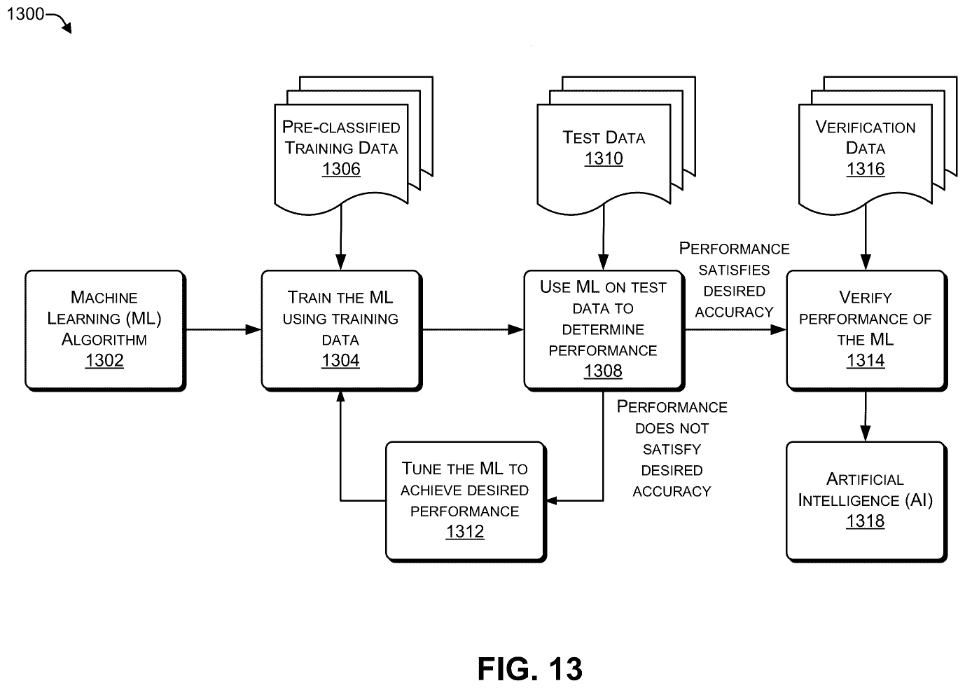

FIG. 13 is a flowchart of a process 1300 to train a machine learning algorithm, according to some cases. The process 1300 is performed during a training phase to train a machine learning algorithm to create an artificial intelligence (AI), such as a neural network (e.g., convolutional neural network), a feature extraction network, or any other type of software applications described herein that can be implemented using artificial intelligence (AI).

At 1302, a machine learning algorithm (e.g., software code) may be created by one or more software designers. At 1304, the machine learning algorithm may be trained (e.g., fine-tuned) using pre-classified training data 1306. For example, the training data 1306 may have been pre-classified by humans, by an AI, or a combination of both. After the machine learning algorithm has been trained using the pre-classified training data 1306, the machine learning may be tested, at 1308, using test data 1310 to determine a performance metric of the machine learning. The performance metric may include, for example, precision, recall, Frechet Inception Distance (FID), or a more complex performance metric. For example, in the case of a classifier, the accuracy of the classification may be determined using the test data 1310.

If the performance metric of the machine learning does not satisfy a desired measurement (e.g., 95%, 98%, 99% in the case of accuracy), at 1308, then the machine learning code may be tuned, at 1312, to achieve the desired performance measurement. For example, at 1312, the software designers may modify the machine learning software code to improve the performance of the machine learning algorithm. After the machine learning has been tuned, at 1312, the machine learning may be retrained, at 1404, using the pre-classified training data 1306. In this way, 1304, 1308, 1312 may be repeated until the performance of the machine learning is able to satisfy the desired performance metric. For example, in the case of a classifier, the classifier may be tuned to classify the test data 1310 with the desired accuracy.

After determining, at 1308, that the performance of the machine learning satisfies the desired performance metric, the process may proceed to 1314, where verification data 1316 may be used to verify the performance of the machine learning. After the performance of the machine learning is verified, at 1314, the machine learning 1302, which has been trained to provide a particular level of performance may be used as an AI, such as the features extractors 218(1), 218(2) of FIG. 2, neural networks (NN) 222(1), 222(2), and other modules described herein that can be implemented using AI.

FIG. 14 is a flowchart of a process 1400 that includes generating a reconstructed 3D pose, according to some embodiments. The process 1400 may be performed by the system 200 or the system 1700 as described herein.

At 1402, the process may receive an image (e.g., photo) that includes one or more persons (humans). At 1404, the process may detect the one or more persons in the image. At 1406, the process may crop an area around individual persons of the one or more persons to isolate the individual persons in the image, thereby creating cropped data. At 1408, the process may resize the cropped data to fit a network input layer. At 1410, the process may perform preprocessing. At 1412, the process may provide the result of the pre-processing to an image-to-abstract network. At 414, the process may determine two-dimensional key points. At 416, the process may determine a limb/part occlusion matrix. At 418, the process may perform first post processing. At 1420, the process may generate an abstract image and send the abstract image to 1422 and to 1426. At 1422, the process may provide the abstract image to an abstract-to-pose network. At 1424, the process may encode the pose and perform second post processing on the encoded pose, at 1430. At 1426, the process may use the abstract image as input to an abstract-to-viewpoint network and encode the resulting viewpoint, at 1428. The process may perform second post processing of the encoded viewpoint, at 1430. At 1432, the process may generate the reconstructed 3-D pose.

For example, in FIG. 2, the image 232 (e.g., photo) that includes one or more persons (humans) may be used as input. The backbone 234 may detect the one or more persons in the image 232. The bounding box detector may crop an area around individual persons of the one or more persons to isolate the individual persons in the image, thereby creating cropped data. The cropped data may be resized to fit a network input layer and perform preprocessing. The image-to-abstract network 201(A) may process the image 232, including determining two-dimensional key points using the 2D pose detector 236. The process may determine the limb/part occlusion matrix 242 using the limb occlusion matrix network 240. The process may perform first post processing 244. The process may generate the abstract image 210 (also referred to as the abstract representation 210) and send the abstract image 210 to the abstract-to-pose network 201(B). The process may encode the pose and perform second post processing on the encoded pose. The process may use the abstract image as input to an abstract-to-viewpoint network 222(1) and encode the resulting viewpoint. The process may perform second post processing of the encoded viewpoint and generate the reconstructed 3-D pose 230.

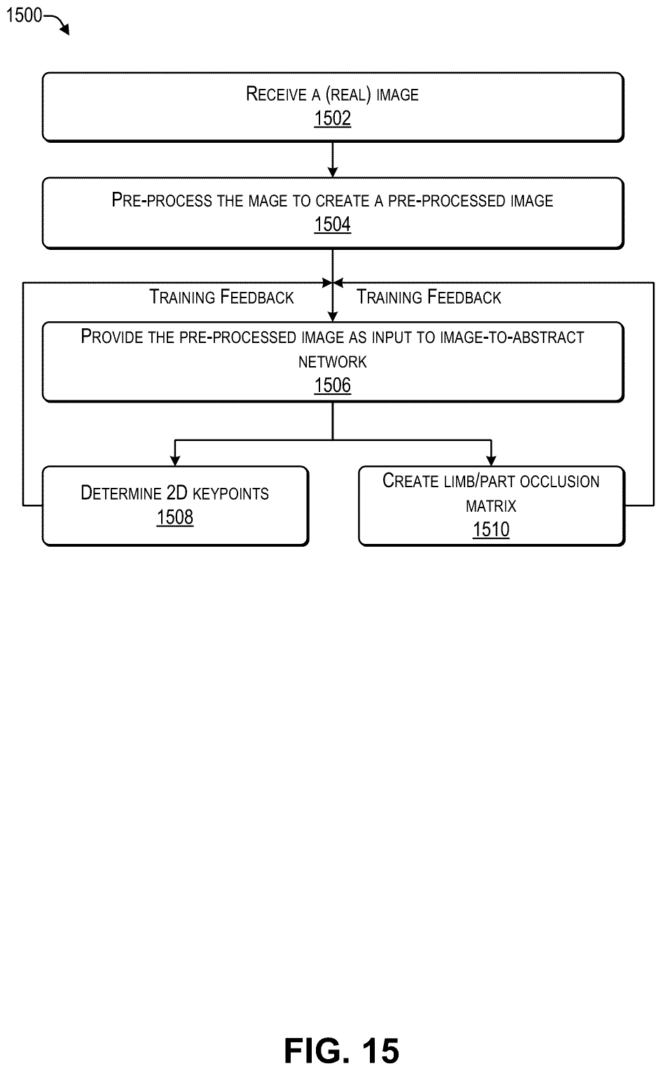

FIG. 15 is a flowchart of a process 1500 that includes providing a pre-processed image as input to an image-to-abstract network, according to some embodiments. The process 1500 may be performed by the system 200 or the system 1700 as described herein.

At 1502, the process may receive a (real) image (e.g., photo). At 1504, the process may preprocessed the image to create a preprocessed image. At 1506, the preprocessed image may be provided as input to an image to abstract network. At 1508, the process may determine two-dimensional key points and then provide training feedback. At 1510, the process may create a limb/part occlusion matrix and provide training feedback.

For example, in FIG. 2, the image 232 (e.g., photo) that includes one or more persons (humans) may be used as input. The system 200 may perform preprocessing and provide the preprocessed image to the image-to-abstract network 201(A), including determining two-dimensional key points using the 2D pose detector 236 and determining the limb/part occlusion matrix 242 using the limb occlusion matrix network 240. The 2D pose detector 236 and the limb occlusion matrix network 240 may both provide training feedback.

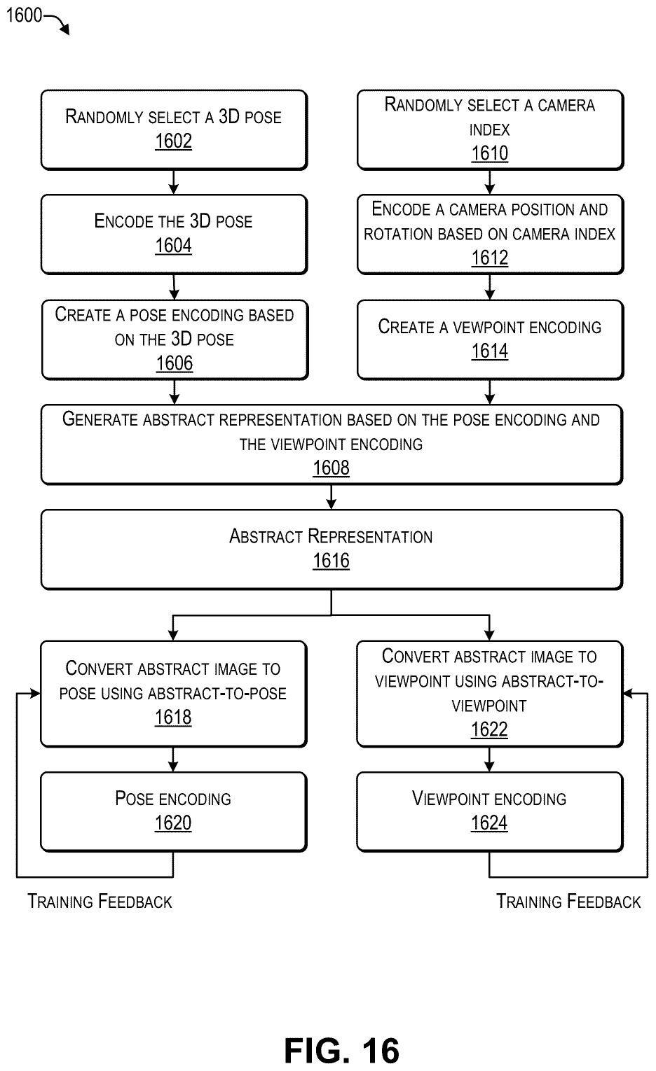

FIG. 16 is a flowchart of a process 1600 that includes generating an abstract representation based on a pose encoding and a viewpoint encoding, according to some embodiments. The process 1600 may be performed by the system 200 or the system 1700 as described herein.

At 1602, the process may randomly select a three-dimensional pose. At 1604, the process may encode the three-dimensional pose. At 1606, the process may create a pose encoding based on the 3-D pose, and proceed to 1608. At 1610, the process may randomly select a camera index from multiple camera viewpoints. At 1612, the process may encode a camera position and rotation (e.g., camera viewpoint) based on the camera index. At 1614, the process may create a viewpoint encoding, and proceed to 1608. At 1608, the process may generate an abstract representation based on the pose encoding from 1606 and the viewpoint encoding from 1614. The process may create an abstract representation, at 1616. At 1618, the process may convert the abstract image to a pose using an abstract-to-pose network and, at 1620 create a pose encoding. After performing the pose encoding, at 1620, the pose encoder may provide training feedback to the abstract-to-pose network. At 1622, the abstract-to-viewpoint network may convert the abstract representation to a viewpoint and encode the viewpoint, at 1624. The viewpoint encoder may provide training feedback to the abstract-to-viewpoint encoder.

The system 200 may convert the abstract representation 210 to a pose using the abstract-to-pose network 201(B) and create a pose encoding. After performing the pose encoding, the pose encoder may provide training feedback to the abstract-to-pose network 201(B). The abstract-to-viewpoint network may convert the abstract representation to a viewpoint and encode the viewpoint.

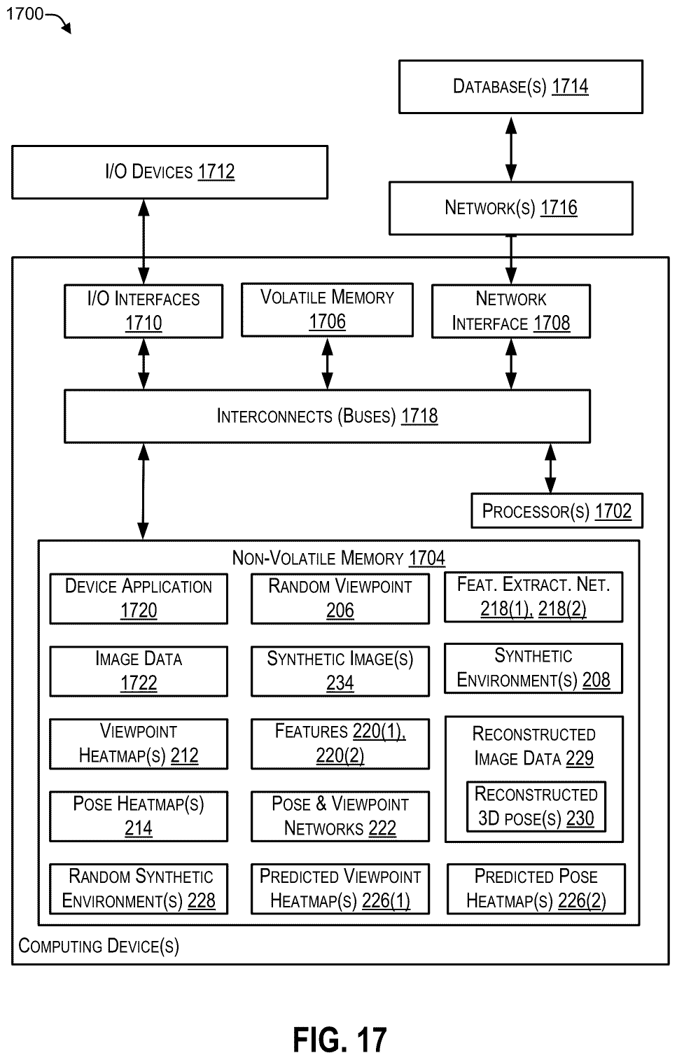

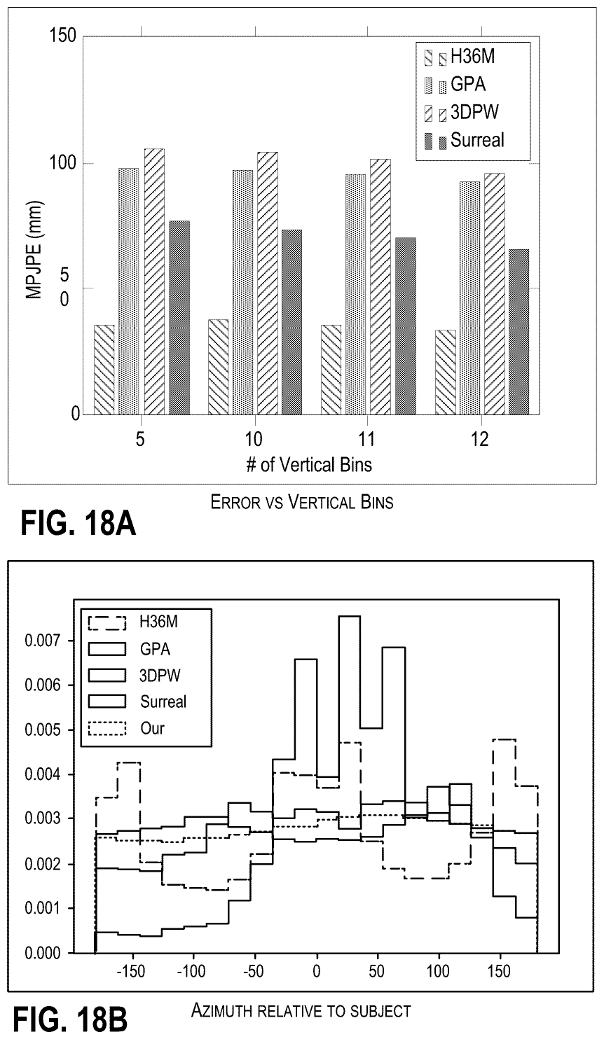

FIG. 17 illustrates an example configuration of a computing device that can be used to implement the systems and techniques described herein.

### Example Computing Device for Performing Human Pose Recognition

FIG. 17 is a block diagram of a computing device 1700 configured to perform human pose recognition using synthetic images and viewpoint encoding in accordance with an embodiment of the invention. Although depicted as a single physical device, in some cases, the computing device may be implemented using virtual device(s), and/or across a number of devices, such as in a cloud environment. The computing device 1700 may be an encoder, a decoder, a combination of encoder and decoder, a display device, a server, multiple servers, or any combination thereof.

As illustrated, the computing device 1700 includes a one or more processor(s) 1702, non-volatile memory 1704, volatile memory 1706, a network interface 1708, and one or more input/output (I/O) interfaces 1710. In the illustrated embodiment, the processor(s) 1702 retrieve and execute programming instructions stored in the non-volatile memory 1704 and/or the volatile memory 1706, as well as stores and retrieves data residing in the non-volatile memory 1704 and/or the volatile memory 1706. In some cases, non-volatile memory 1704 is configured to store instructions (e.g., computer-executable code, software application) that when executed by the processor(s) 1702, cause the processor(s) 1702 to perform the processes and/or operations described herein as being performed by the systems and techniques and/or illustrated in the figures. In some cases, the non-volatile memory 1704 may store code for executing the functions of an encoder and/or a decoder. Note that the computing device 1700 may be configured to perform the functions of only one of the encoder or the decoder, in which case additional system(s) may be used for performing the functions of the other. In addition, the computing device 1700 might also include some other devices in the form of wearables such as, but not limited to headsets (e.g., a virtual reality (VR) headset), one or more input and/or output controllers with an inertia motion sensor, gyroscope(s), accelerometer(s), etc. In some cases, these other devices may further assist in getting accurate position information of a 3D human pose.

The processor(s) 1702 are generally representative of a single central processing unit (CPU) and/or graphics processing unit (GPU), tensor processing unit (TPU), neural processing unit (NPU), multiple CPUs and/or GPUs, a single CPU and/or GPU having multiple processing cores, and the like. Volatile memory 1706 include random access memory (RAM) and the like. Non-volatile memory 1704 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some cases, I/O devices 1712 (such as keyboards, monitors, cameras, VR headsets, scanners, charge-coupled device (CCD), gravitometers, accelerometers, initial measurement units (IMUs), gyroscopes, or anything that can capture an image, detect motion, etc.) can be connected via the I/O interface(s) 1710. Further, via any communication interface including but not limited to Wi-Fi, Bluetooth, cellular modules, etc., the computing device 1700 can be communicatively coupled with one or more other devices and components, such as one or more databases 1714. In some cases, the computing device 1700 is communicatively coupled with other devices via a network 1716, which may include the Internet, local network(s), and the like. The network 1716 may include wired connections, wireless connections, or a combination of wired and wireless connections. As illustrated, processor(s) 1702, non-volatile memory 1704, volatile memory 1706, network interface 1708, and I/O interface(s) 1710 are communicatively coupled by one or more bus interconnects 1718. In some cases, the computing device 1700 is a server executing in an on-premises data center or in a cloud-based environment. In certain embodiments, the computing device 1700 is a user's mobile device, such as a smartphone, tablet, laptop, desktop, or the like.

In the illustrated embodiment, the non-volatile memory 1704 may include a device application 1720 that configures the processor(s) 1702 to perform various processes and/or operations in human pose recognition using synthetic images and viewpoint encoding, as described herein. The computing device 1700 may be configured to perform human pose recognition. For example, the computing device 1700 may be configured to perform a training phase (e.g., training phase 202 of FIG. 2) that may include generating the abstract image 210, the viewpoint heatmaps 212, and a plurality of pose heatmaps 214 using a synthetic environment 208. In some cases, the training phase 202 may include conducting feature extraction on the synthetic image 234 using feature extraction networks 218(1), 218(2), where the feature extraction networks 218 extract features 220(1), 220(2) from the synthetic image 234 and provide the extracted features 220 to pose network 222(2) and viewpoint network 222(1). In addition, in some case, the training phase 202 may include optimizing (minimizing) a first L2 loss on the viewpoint network 222(1) with the viewpoint heatmap 212 and optimizing (minimizing) a second L2 loss on the pose network 222(2) with the plurality of pose heatmaps 214.

The computing device 1700 may be configured to perform human pose recognition by performing the reconstruction phase 203 of FIG. 2 that may include receiving the synthetic image 234 and generating a predicted viewpoint heatmap 226(1) and a plurality of predicted pose heatmaps 226(2). In some cases, the reconstruction phase 203 may include reconstructing a 3D pose to create a reconstructed 3D pose 230 in a random synthetic environment (reconstructed image data 229). As described herein, images, including image data 1722, may be used to generate synthetic (abstract) images 234. However, in some cases, the synthetic images 234 may be received from an external source (e.g., external databases) rather than created by the computing device 1700. In some cases, the computing device 1700 or external computing devices connected to the computing device 1700 may process or refine the pose estimate.

Further, although specific operations and data are described as being performed and/or stored by a specific computing device above with respect to FIG. 17, in certain embodiments, a combination of computing devices may be utilized instead. In addition, various operations and data described herein by be performed and/or stored by the computing device.

FIG. 18A illustrates data of error vs vertical bins for several techniques, based on experimental data. FIG. 18A shows how the global cross-dataset error changes as the number of vertical bins is increased. FIG. 18B illustrates azimuth relative to subject for several techniques, based on experimental data. FIG. 18B demonstrates how the synthetic training set described herein that uses a large number of synthetic viewpoints is able to level (relatively) the distribution of trained viewpoints in azimuth. FIG. 18C illustrates elevation relative to subject for several techniques, based on experimental data. FIG. 18C demonstrates how the synthetic training set described herein that uses a large number of synthetic viewpoints is able to level (relatively) the distribution of trained viewpoints in elevation.

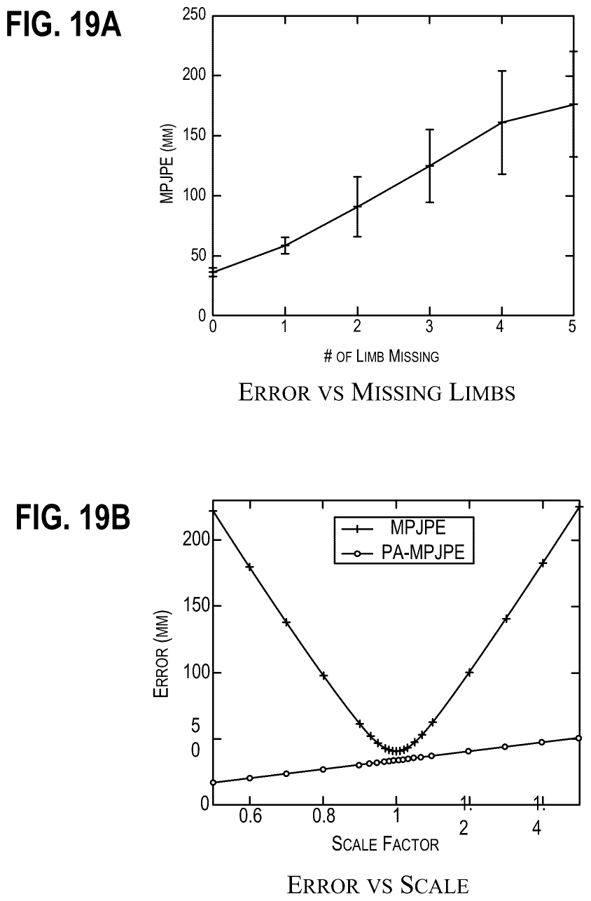

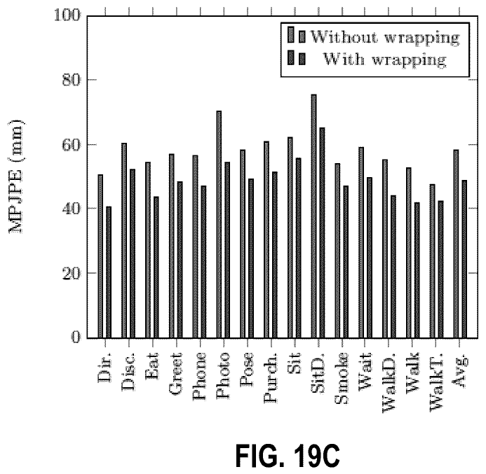

FIG. 19A illustrates error vs missing limbs for several techniques, based on experimental data. FIG. 19A shows the relationship between Mean Per Joint Position Error (MPJPE) vs number of missing parts. As more parts are missing from the input image, error and uncertainty increases.

FIG. 19B illustrates error as a function of scaled bone length in a synthetic environment, based on experimental data. As illustrated, error increases as the scale deviates 1.0. Note that Procrustes analysis-MPJPE (PA-MPJPE) applies affine transformation which compensates for scale difference.

FIG. 19C illustrates an effect of wrapping, based on experimental data. The darker lines show an amount of error with wrapping while the lighter lines show an amount of error without wrapping. The errors are plotted across different actions on a dataset and illustrate that wrapping is clearly better.

Each of these non-limiting examples can stand on its own or can be combined in various permutations or combinations with one or more of the other examples. The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” In this document, the term “set” or “a set of” a particular item is used to refer to one or more than one of the particular item.

Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several cases, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer-implemented method comprising:
receiving a real image that includes a human, the real image comprising a photograph or a frame of a video;
creating a synthetic image corresponding to the real image, the synthetic image including a synthetic environment and a humanoid shape that correspond to the human;
predicting, using a trained viewpoint network and based on the synthetic image, a predicted viewpoint heatmap, the trained viewpoint network comprising a first trained convolutional neural network;
predicting, using a trained pose network and based on the synthetic image, a predicted pose heatmap, the trained pose network comprising a second trained convolutional neural network;
providing, as input to a random synthetic environment, the predicted viewpoint heatmap and the predicted pose heatmap;
creating a reconstructed three-dimensional pose based on the predicted viewpoint heatmap, the predicted pose heatmap, and the random synthetic environment; and
classifying the reconstructed three-dimensional pose as a particular type of pose of the human in the real image.

2. The computer-implemented method of claim 1, further comprising:
determining that at least one of the predicted viewpoint heatmap or the predicted pose heatmap specify a Gaussian heatmap that warps around a vertical edge or a horizontal edge of the synthetic image.

3. The computer-implemented method of claim 1, further comprising:
determining, that at least one of the predicted viewpoint heatmap or the predicted pose heatmap include more than three dimensions.

4. The computer-implemented method of claim 1, further comprising:
determining, that at least one of the predicted viewpoint heatmap or the predicted pose heatmap include a time dimension.

5. The computer-implemented method of claim 1, wherein creating the reconstructed three-dimensional pose based on the predicted viewpoint heatmap, the predicted pose heatmap, and the random synthetic environment comprises:
decomposing a human pose of the human into bone vectors and bone lengths that are relative to a parent joint; and
transforming a camera position of the synthetic image from subject-centered coordinates to world coordinates.

6. The computer-implemented method of claim 1, further comprising:
wrapping a matrix in a geometric formation including defining an encoding in which a seam line is at a back of the humanoid shape and opposite a forward vector.

7. The computer-implemented method of claim 1, wherein creating the reconstructed three-dimensional pose based on the predicted viewpoint heatmap, the predicted pose heatmap, and the random synthetic environment comprises:
transforming a camera's position from subject-centered coordinates to world coordinates.

8. A computing device comprising:
one or more processors; and
a non-transitory memory device to store instructions executable by the one or more processors to perform operations comprising:
receiving a real image that includes a human, the real image comprising a photograph or a frame of a video;
creating a synthetic image corresponding to the real image, the synthetic image including a synthetic environment and a humanoid shape that correspond to the human;
predicting, using a trained viewpoint network and based on the synthetic image, a predicted viewpoint heatmap, the trained viewpoint network comprising a first trained convolutional neural network;
predicting, using a trained pose network and based on the synthetic image, a predicted pose heatmap, the trained pose network comprising a second trained convolutional neural network;
providing, as input to a random synthetic environment, the predicted viewpoint heatmap and the predicted pose heatmap;
creating a reconstructed three-dimensional pose based on the predicted viewpoint heatmap, the predicted pose heatmap, and the random synthetic environment; and
classifying the reconstructed three-dimensional pose as a particular type of pose of the human in the real image.

9. The computing device of claim 8, wherein the trained pose network and the trained viewpoint network are created by:
randomly selecting a pose from a set of poses;
randomly selecting a viewpoint from a set of viewpoints;
generating the synthetic environment based at least in part on the pose and the viewpoint; and
deriving, from the synthetic environment, an abstract representation, a viewpoint heatmap, and a pose heatmap, wherein the viewpoint heatmap and the pose heatmap are used as supervised training targets.

10. The computing device of claim 9, the operations further comprising:
extracting, using a first feature extraction neural network to extract first features from the synthetic environment and the abstract representation;
training a viewpoint network using the first features to create the trained viewpoint network;
extracting, using a second feature extraction neural network to extract second features from the synthetic environment and the abstract representation; and
training a pose network using the second features to create the trained pose network.

11. The computing device of claim 10, the operations further comprising:
minimizing a viewpoint L2 loss for a viewpoint output of the viewpoint network; and
minimizing a pose L2 loss for a pose output of the pose network.

12. The computing device of claim 8, further comprising:
creating multiple tiles based on the synthetic image, wherein the multiple tiles include:
a limb tile for each limb of the humanoid shape; and
a torso tile for a torso of the humanoid shape.

13. The computing device of claim 9, further comprising:
adding perlin noise to the synthetic image to introduce granular missing patches.

14. A non-transitory computer-readable memory device configured to store instructions executable by one or more processors to perform operations comprising:
receiving a real image that includes a human, the real image comprising a photograph or a frame of a video;
creating a synthetic image corresponding to the real image, the synthetic image including a synthetic environment and a humanoid shape that correspond to the human;
predicting, using a trained viewpoint network and based on the synthetic image, a predicted viewpoint heatmap, the trained viewpoint network comprising a first trained convolutional neural network;
predicting, using a trained pose network and based on the synthetic image, a predicted pose heatmap, the trained pose network comprising a second trained convolutional neural network;
providing, as input to a random synthetic environment, the predicted viewpoint heatmap and the predicted pose heatmap;
creating a reconstructed three-dimensional pose based on the predicted viewpoint heatmap, the predicted pose heatmap, and the random synthetic environment; and
classifying the reconstructed three-dimensional pose as a particular type of pose of the human in the real image.

15. The non-transitory computer-readable memory device of claim 14, further comprising:
determining that at least one of the predicted viewpoint heatmap or the predicted pose heatmap specify a fuzzy location.

16. The non-transitory computer-readable memory device of claim 14, further comprising:
determining, that at least one of the predicted viewpoint heatmap or the predicted pose heatmap include more than three dimensions.

17. The non-transitory computer-readable memory device of claim 14, further comprising:
determining, that at least one of the predicted viewpoint heatmap or the predicted pose heatmap include a time dimension.

18. The non-transitory computer-readable memory device of claim 14, wherein the trained pose network and the trained viewpoint network are created by:
randomly selecting a pose from a set of poses;
randomly selecting a viewpoint from a set of viewpoints;
generating the synthetic environment based at least in part on the pose and the viewpoint; and
deriving, from the synthetic environment, an abstract representation, a viewpoint heatmap, and a pose heatmap, wherein the viewpoint heatmap and the pose heatmap are used as supervised training targets.

19. The non-transitory computer-readable memory device of claim 18, the operations further comprising:
extracting, using a first feature extraction neural network to extract first features from the synthetic environment and the abstract representation;
training a viewpoint network using the first features to create the trained viewpoint network;
extracting, using a second feature extraction neural network to extract second features from the synthetic environment and the abstract representation; and
training a pose network using the second features to create the trained pose network.

20. The non-transitory computer-readable memory device of claim 14, wherein creating the reconstructed three-dimensional pose based on the predicted viewpoint heatmap, the predicted pose heatmap, and the random synthetic environment comprises:
transforming a camera's position from subject-centered coordinates to world coordinates.
